(19) United States
(12) Patent Application Publication
(10) Pub. No.: US 2026/0111193 A1
(43) Pub. Date: Apr. 23, 2026

(54) SYSTEMS AND METHODS FOR WORKFLOWS IN A TIERED SOFTWARE FRAMEWORK

(71) Applicant: HighLevel Inc., Dallas, TX (US)

(72) Inventors: Kiran Raparti, Hyderabad (IN); Nikunj Kanetiya, Rajkot (IN); Baibhab Mondal, Bardhaman (IN); Sharad Vijay Shinde, Pune (IN); Kewal Gangar, Dombiwali (IN); Narendra Kumar L, Sivakasi (IN); Ravalika Chelumalla, Hyderabad (IN); Minaz Sayyad, Pune (IN); Prasoon Dadhich, Udaipur (IN); Abhishek Chauhan, Pune (IN); Shaun Clark, Eugene, OR (US); Robin Alex, Dallas, TX (US); Varun Vairavan, Doha (QA)

(73) Assignee: HighLevel Inc., Dallas, TX (US)

(21) Appl. No.: 19/333,446

(22) Filed: Sep. 19, 2025

Related U.S. Application Data
(60) Provisional application No. 63/708,917, filed on Oct. 18, 2024.

(51) Int. Cl. G06F 8/36; G06F 8/71

(52) U.S. Cl. CPC G06F 8/36; G06F 8/71

(57) ABSTRACT

A workflow builder includes a plurality of user interfaces (UIs) that allow a user to configure workflow-objects and build workflows therefrom. The plurality of UIs includes a first UI to configure workflow-objects and a second UI to build a workflow using the workflow-objects, the plurality of UIs being in a marketplace platform of a tiered software framework having a plurality of tiers with accounts in downstream tiers subscribed to different accounts in upstream tiers. Preconfigured workflow-objects are provided in the first UI as also an option to use custom scripts or preconfigured UI elements to configure the preconfigured workflow-objects into new workflow-objects. In the second UI, a layout comprising a visual mapping of interconnected workflow-objects is provided, along with a selection comprising the workflow-objects configured in the first UI. The configured workflow-objects and workflow are thereafter automatically pushed to a marketplace or to subscribed accounts.

### CROSS REFERENCE TO RELATED APPLICATIONS

This Application claims the benefit of priority to U.S. Provisional Patent Application Ser. No. 63/708,917 filed on Oct. 18, 2024, entitled SYSTEMS AND METHODS FOR BUILDING WORKFLOWS IN A TIERED SOFTWARE FRAMEWORK. The disclosure of the prior application is considered part of and is hereby incorporated by reference in its entirety in the disclosure of this Application.

### BACKGROUND

Low-code and no-code software applications are transformative tools that allow users to create and customize digital solutions without any programming knowledge. By utilizing intuitive drag-and-drop interfaces and pre-built templates, these platforms enable individuals and teams to streamline tasks, enhance productivity, and integrate various applications seamlessly. This democratization of technology allows non-technical users to design and implement solutions tailored to their specific needs, fostering creativity and efficiency in business operations. As organizations increasingly embrace digital transformation, low-code and no-code software play a crucial role in accelerating development cycles and reducing reliance on computing resources.

### BRIEF DESCRIPTION OF DRAWINGS

Embodiments will be readily understood by the following detailed description in conjunction with the accompanying drawings. To facilitate this description, like reference numerals designate like elements. Embodiments are illustrated by way of example, and not by way of limitation, in the figures of the accompanying drawings.

FIGS. 1A-1B are simplified block diagrams illustrating an example system for building workflows in a tiered software framework.

FIG. 2 is a simplified block diagram illustrating details of an example system for building workflows in a tiered software framework.

FIG. 3 is a simplified block diagram illustrating other details of an example system for building workflows in a tiered software framework.

FIGS. 4A-4B are simplified block diagrams illustrating other details of an example system for building workflows in a tiered software framework.

FIGS. 5A-5B are simplified block diagrams illustrating other details of an example system for building workflows in a tiered software framework.

FIG. 6 is a simplified block diagram illustrating other details of an example system for building workflows in a tiered software framework.

FIG. 7 is a simplified flow diagram illustrating an example method for building workflows in a tiered software framework.

FIG. 8 is a simplified sequence diagram illustrating another example method for building workflows in a tiered software framework.

FIG. 9 is a simplified flow diagram illustrating another example method for building workflows in a tiered software framework.

FIG. 10 is a simplified sequence diagram illustrating another example method for building workflows in a tiered software framework.

FIG. 11 is a simplified diagram illustrating other details of an example user interface for building workflows in a tiered software framework.

FIG. 12 is a simplified diagram illustrating other details of an example user interface for building workflows in a tiered software framework.

FIG. 13 is a simplified diagram illustrating other details of an example user interface for building workflows in a tiered software framework.

FIGS. 14A-14F are simplified diagrams illustrating other details of an example user interface for building workflows in a tiered software framework.

FIG. 15 is a simplified diagram illustrating other details of an example user interface for building workflows in a tiered software framework.

FIG. 16 is a simplified diagram illustrating other details of an example user interface for building workflows in a tiered software framework.

FIG. 17 is a simplified diagram illustrating other details of an example user interface for building workflows in a tiered software framework.

FIGS. 18A-18C are simplified diagrams illustrating other details of an example user interface for building workflows in a tiered software framework.

FIGS. 19A-19E are simplified diagrams illustrating other details of an example user interface for building workflows in a tiered software framework.

FIG. 20 is a simplified diagram illustrating other details of an example user interface for building workflows in a tiered software framework.

FIG. 21 is a simplified flow diagram illustrating details of an example method for building workflows in a tiered software framework.

FIG. 22 is a simplified flow diagram illustrating other details of the example method for building workflows in a tiered software framework.

### DESCRIPTION

For purposes of illustrating the embodiments described herein, it is important to understand certain terminology and operations of technology networks. The following foundational information may be viewed as a basis from which the present disclosure may be properly explained. Such information is offered for purposes of explanation only and, accordingly, should not be construed in any way to limit the broad scope of the present disclosure and its potential applications.

Workflow builders have evolved as a response to the growing need for businesses to automate processes, streamline operations, and improve efficiency. Traditionally, creating workflows involved complex coding and a deep understanding of programming languages, which limited access to technical experts and developers. As organizations recognized the need for agility and rapid adaptability in their operations, the demand for simpler, more accessible solutions emerged. With advancements in user interface design and the increasing prevalence of cloud computing, developers began to create platforms that allowed users to visually map out processes using intuitive drag-and-drop tools. In no-code software development, instead of relying on syntax and manual coding, users interact with visual interfaces, drag-and-drop components, and pre-built logic to define how their application behaves. No-code platforms provide modular building blocks, such as data models, user interface components, automation tools, and integrations with other services, all configurable through simple settings or visual flows. These no-code solutions democratized the process of workflow creation, enabling non-technical users to automate tasks and integrate various applications without writing a single line of code.

The rise of no-code workflow builders coincided with the broader trend of digital transformation, where organizations sought to leverage technology for operational efficiency. As businesses increasingly embraced automation, no-code platforms gained traction, allowing users to quickly prototype, iterate, and implement workflows tailored to their specific needs. This shift not only accelerated innovation but also empowered a new generation of users to take charge of their processes, fostering a culture of agility and continuous improvement within organizations.

Low-code software development is another approach that combines visual development tools of no-code with the ability to write minimal, custom code to build applications more efficiently. Unlike no-code platforms, which aim to eliminate coding altogether, low-code platforms strike a balance by allowing developers to use drag-and-drop interfaces for most of the application logic while still offering the flexibility to insert custom code where needed, such as for advanced integrations, complex business rules, or performance optimizations.

Currently available workflow builders such as Hubspot™, Microsoft Power Automate™, Trello™, Monday.com™, Mailchimp™, etc. provide various types of functionalities and flows for no-code or low-code workflow builders. Examples include: build automated workflows for customer relationship management based on user behavior and interactions; connect and automate tasks between many applications based on trigger events; create workflows with conditional logic and integrations across numerous applications; build custom workflows to manage projects; create automated workflows between proprietary applications and other services; automate repetitive tasks within boards; link databases and task management systems; create custom workflows using a custom interface; create custom tools for modifying workflows; and others. The market continues to grow, with many platforms adding features such as artificial intelligence (AI) integration, enhanced collaboration tools, and better user experiences. This evolution reflects the increasing demand for accessible automation solutions across industries, enabling organizations of all sizes to enhance productivity and efficiency.

However, such general workflow builders are incompatible with certain proprietary platforms that have specific functionalities that are not available or accessible outside such platforms. In such a scenario, a custom workflow builder may be tailored for that specific platform, utilizing the functionalities and attributes of that platform. Accordingly, embodiments of the workflow builder in the tiered software framework provide a system and method for generating a custom workflow based on trigger events that are specific within a proprietary platform. The proprietary platform includes a tiered software framework that includes a plurality of tiers in hierarchical configuration, each upstream tier separated from downstream tiers by data access policies. Data in the first tier is accessible to the first tier and inaccessible to the second and third tiers; data in the second tier is accessible to the first tier and second tier but not to the third tier; and data in the third tier is accessible to the first, second and third tier. In various embodiments, the automated workflow builder enables generating an automated workflow within this tiered context that adheres to the data access policies without the user having to be aware of these policies. In various embodiments, the workflow may be built on a “marketplace” platform and made available as an application to other users. In some embodiments, at the touch of a button, the completed workflow builder may be pushed from the second tier to several accounts in the third tier. In some embodiments, the workflow builder is generated and executes in a sandbox separate from the tiered software framework with calls to the tiered software framework and data access from the tiered software framework being handled at the appropriate tier by suitable overseer modules in the tiered software framework.

In the following detailed description, various aspects of the illustrative implementations may be described using terms commonly employed by those skilled in the art to convey the substance of their work to others skilled in the art.

The term “coupled” means either a direct connection between the things that are connected, or an indirect connection through one or more passive or active intermediary devices.

The term “computing device” means a server, a desktop computer, a laptop computer, a smartphone, or any device with a microprocessor, such as a central processing unit (CPU), general processing unit (GPU), or other such electronic component capable of executing processes of a software algorithm (such as a software program, code, application, macro, etc.).

The term “cloud network” or simply “cloud” means a network of computing devices coupled together in a public, private, or hybrid communications network. Communication in the cloud network may use one or more wired, wireless, broadband, radio, and other kinds of communicative means. The Internet is an example of a cloud network.

The term “application” can be inclusive of an executable file comprising instructions that can be understood and processed on a computing device such as a computer, and may further include library modules loaded during execution, object files, system files, hardware logic, software logic, or any other executable modules. Applications are generally configured to perform particular tasks, or functions according to the type of application.

The term “workflow” refers to a defined sequence of actions (e.g., operations, processes, steps, tasks, etc.) that are carried out automatically to complete a specific functionality of an application. It includes a start point (e.g., trigger such as user input, form submission, etc.), a sequence of actions, a decision logic (e.g., conditional paths or rules that determine how the sequence proceeds), actors (e.g., software modules that execute functions of the actions) and an end point that completes the workflow.

The description uses the phrases “in an example” or “in examples,” which may each refer to one or more of the same or different examples.

Although certain elements may be referred to in the singular herein, such elements may include multiple sub-elements. For example, “a computing device” may include one or more computing devices.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

In the following detailed description, reference is made to the accompanying drawings that form a part hereof, and in which is shown, by way of illustration, examples that may be practiced. It is to be understood that other examples may be utilized, and structural or logical changes may be made without departing from the scope of the present disclosure. Therefore, the following detailed description is not to be taken in a limiting sense.

The accompanying drawings are not necessarily drawn to scale. In the drawings, same reference numerals refer to the same or analogous elements shown so that, unless stated otherwise, explanations of an element with a given reference numeral provided in context of one of the drawings are applicable to other drawings where element with the same reference numerals may be illustrated. Further, the singular and plural forms of the labels may be used with reference numerals to denote a single one and multiple ones respectively of the same or analogous type, species, or class of element.

Note that in the figures, various components are shown as aligned, adjacent, or physically proximate merely for ease of illustration; in actuality, some or all of them may be spatially distant from each other. In addition, there may be other components, such as routers, switches, antennas, communication devices, etc. in the networks disclosed that are not shown in the figures to prevent cluttering. Systems and networks described herein may include, in addition to the elements described, other components and services, including network management and access software, connectivity services, routing services, firewall services, load balancing services, content delivery networks, virtual private networks, etc. Further, the figures are intended to show relative arrangements of the components within their systems, and, in general, such systems may include other components that are not illustrated (e.g., various electronic components related to communications functionality, electrical connectivity, etc.).

In the drawings, a particular number and arrangement of structures and components are presented for illustrative purposes and any desired number or arrangement of such structures and components may be present in various examples. Further, unless otherwise specified, the structures shown in the figures may take any suitable form or shape according to various design considerations, manufacturing processes, and other criteria beyond the scope of the present disclosure.

For convenience, if a collection of drawings designated with different letters are present, such a collection may be referred to herein without the letters. Similarly, if a collection of reference numerals designated with different letters are present (e.g., 106a, 106b), such a collection may be referred to herein without the letters (e.g., as “106”) and individual ones in the collection may be referred to herein with the letters. Further, labels in upper case in the figures (e.g., 106A) may be written using lower case in the description herein (e.g., 106a) and should be construed as referring to the same elements.

Various operations may be described as multiple discrete actions or operations in turn in a manner that is most helpful in understanding the claimed subject matter. However, the order of description should not be construed as to imply that these operations are necessarily order dependent. In particular, these operations may not be performed in the order of presentation. Operations described may be performed in a different order from the described example.

Various additional operations may be performed, and/or described operations may be omitted in additional examples.

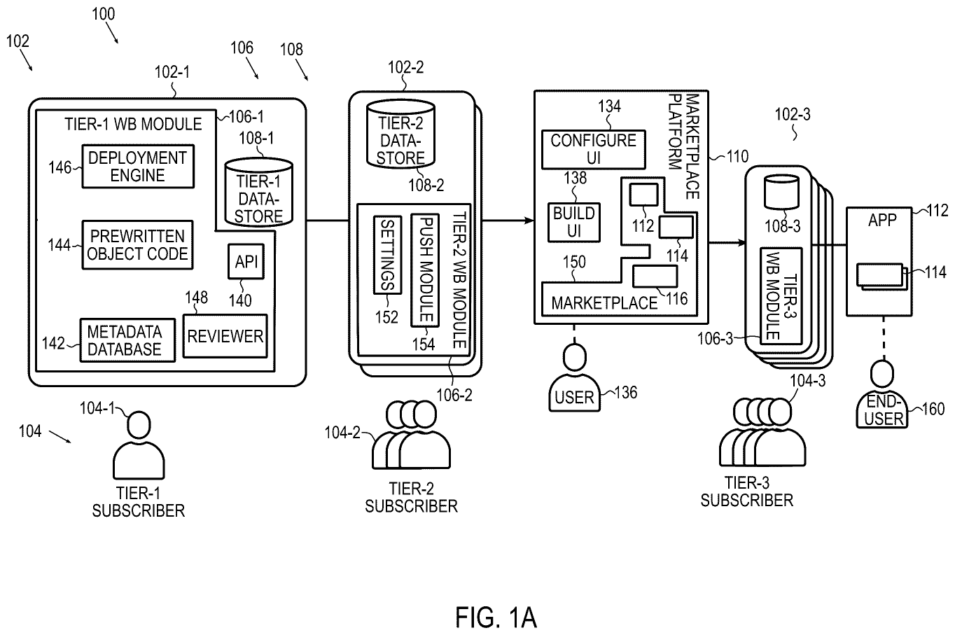

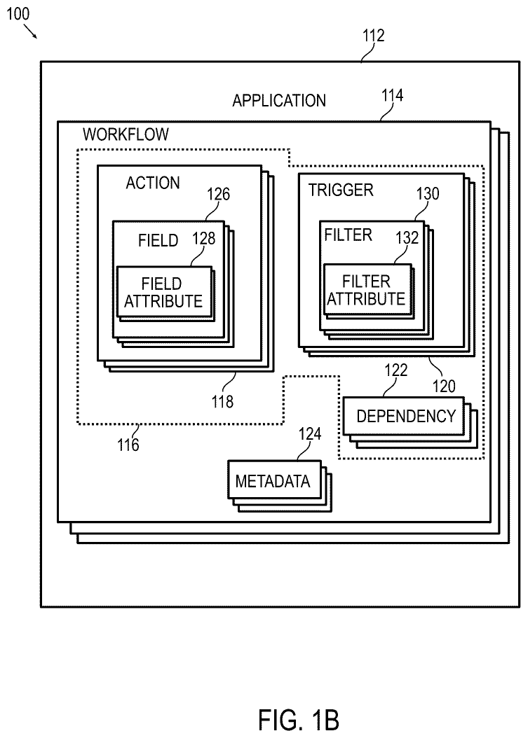

FIG. 1A is a simplified block diagram illustrating an example workflow builder 100 for building workflows in a tiered software framework. Workflow builder 100 comprises various tiers 102. In the example shown, three tiers are shows, namely first tier 102-1, second tier 102-2 and third tier 102-3. Note that the labeling convention followed herein uses the hyphen followed by a number to denote a separate tier corresponding to the number (e.g., “−1” denotes the first tier, “−2” denotes the second tier, and “−3” denotes the third tier). Tiers 102 are accessed by subscribers 104 according to access credentials based on their respective tiers 102. For example, first-tier subscribers 104-1 have access to first tier 102-1, second tier 102-2, and third tier 102-3; second-tier subscribers 104-2 have access to second tier 102-2 and third tier 102-3; and third-tier subscribers 104-3 have access only to third tier 102-3.

Tiers 102 may be organized according to a hierarchy of management (i.e., to oversee, to control, to maintain), with upstream tiers managing downstream ones. Thus, first tier 102-1 comprises operations that may manage second tier 102-2 and third tier 102-3, whereas second tier 102-2 comprises operations that may manage third tier 102-3 but not first tier 102-1. For purposes of terminology, first tier 102-1 is “upstream” relative to second tier 102-2 and third tier 102-3; third tier 102-3 is “downstream” relative to second tier 102-2 and first tier 102-1; second tier 102-2 is downstream relative to first tier 102-1 and upstream relative to third tier 102-3. In some examples, each tier 102 may interact with the tier immediately adjacent thereto (e.g., downstream or upstream) but not with non-adjacent tiers.

Workflow builder 100 may be managed by one of first-tier subscribers 104-1 providing one or more downstream second-tier subscribers 104-2 with access to certain functionalities of workflow builder 100. In turn, any one of second-tier subscribers 104-2 may provide one or more downstream third-tier subscribers 104-3 with access to certain other functionalities of workflow builder 100. In various examples, the functionalities available to first-tier subscribers 104-1 may not be the same as those available to second-tier subscribers 104-2, which may be different from those available to third-tier subscribers 104-3. In one example, functionalities available to third-tier subscribers 104-3 may be a subset of functionalities available to second-tier subscribers 104-2.

Subscribers 104 (e.g., 104-1, 104-2 and 104-2) may include an entity (i.e., a company, an organization, etc.) in various examples. In an example, first-tier subscribers 104-1 may be software-as-a-service (SaaS) providers, second-tier subscribers 104-2 may comprise marketing agencies, and third-tier subscribers 104-3 may comprise individual businesses, such as plumbers, dentists, pet stores, etc. In some examples in which second-tier subscribers 104-2 are marketing agencies, that they are interchangeably referred to herein as “agency” or “agencies.” In some examples in which third-tier subscribers 104-3 are businesses trying to market their brands, they are interchangeably referred to herein as “brand” or “brands.” Agencies may provide services for one or more brands, whereas each brand is typically separate from other brands.

Human users at subscribers 104 may operate or otherwise use workflow builder 100 through one or more computing devices such as computers, laptops, smartphones, mobile computing devices, mobile phones, iPads™, Google Droids™, Microsoft® Surface™, etc. In various examples, a single one of first-tier subscribers 104-1 may have multiple second-tier subscribers 104-2; a single one of second-tier subscribers 104-2 may have multiple third-tier subscribers 104-3. Each one of second-tier subscribers 104-2 may have an account with one of first-tier subscribers 104-1; each one of third-tier subscribers 104-3 may have an account with one of second-tier subscribers 104-2. In other words, there may be a one-to-many relationship downstream (e.g., from first tier 102-1 to second tier 102-2 to third tier 102-3), and a one-to-one relationship upstream (e.g., from third tier 102-3 to second tier 102-2 to first tier 102-1).

In various examples, workflow builder 100 includes a workflow builder module 106 (WB module) executing at three tiers: first-tier WB module 106-1; second-tier WB module 106-2; and third-tier WB module 106-3. In some examples, third-tier WB module 106-3 is substantially identical to second-tier WB module 106-2. In some other examples, third-tier WB module 106-3 may have a subset of functionalities of second-tier WB module 106-2. A data store 108 operates at tiers 102 as follows: a first-tier data store 108-1 includes all data in workflow builder 100 accessible at first tier 102-1 to a particular one of first-tier subscribers 104-1; a second-tier data store 108-2 includes all data in workflow builder 100 accessible at second tier 102-2 to a particular one of second-tier subscribers 104-2; a third-tier data store 108-3 includes all data in workflow builder 100 accessible at third tier 102-3 to a particular one of third-tier subscribers 104-3. Each one of subscribers 104 has access to data store 108 at their particular tier 102 and their account.

A marketplace platform 110 facilitates offering one or more of an application 112; a workflow 114; and a workflow-object 116 for sharing with other users. Workflow 114 and/or workflow-object 116 may be built using workflow builder 100 as described herein. Marketplace platform 110 comprises a user interface with underlying software infrastructure that allows connecting multiple buyers and sellers of application 112, workflow 114 and workflow-object 116 (among other products and services). Marketplace platform 110 provides the tools and features necessary to manage everything from product listings, inventory, and payments to customer reviews, shipping, and seller onboarding within a single platform in the tiered software framework. In addition to offering application 112, workflow 114, and workflow-object 116 for sale, purchase or other types of sharing, marketplace platform 110 enables building application 112, workflow 114, and workflow-object 116 on the same user interface and software infrastructure.

FIG. 1B provides more details of application 112, workflow 114 and workflow-object 116 in workflow builder 100. The term “workflow-object” as used herein refers to an action 118, a trigger 120, or a dependency 122 between and among action 118 and trigger 120 (e.g., an action commences upon the execution of a trigger; an action is initiated after completion of another action, etc.). Action 118 represents a discrete operation, such as sending an email, updating a customer record, calling an external service, etc. that may later be executed as part of automated workflow 114. Trigger 120 represents an event, such as the result of one action 118, on which another action 118 is conditioned. Each workflow-object 116 has metadata 124 associated therewith, comprising all aspects thereof that are necessary to review, compile, execute, and troubleshoot workflow 114. Examples of metadata 124 includes configuration, style, code, timestamp of execution, timestamp of edits, user interactions, system actions, database, fields, field attributes, filters, filter attributes, conditions, calculations, dependencies, application programming interface (API) activities (e.g., get, put, post, share, etc.), application lifecycle management, deployment, releases, server allocation, geo-caching, memory caching, users, authentication, security, encryption, maintenance, and so forth.

Action 118 includes one or more of a field 126, each field 126 having one or more of a field attribute 128. Field attribute 128 varies according to field 126. For example, action 118 may include field 126 for specifying a name of the action, and field attribute 128 may be the value of the name given thereto. Examples of field 126 include: name, dimensions, data type, size, description, etc. In some examples, field attribute 128 may be input by the end-user; in some other examples, field attribute 128 may be preconfigured and unchangeable; in yet other examples, field attribute 128 may have a default value that can be changed during building of action 118. In some examples, field 126 depends on action 118. For example, action 118 may be a step in filling a form; field 126 may be a user interface element, say a radio button for selecting between various options, and field attribute 128 may be the labels and values of the various options. Various other possibilities are included within the broad scope of the examples herein. Trigger 120 includes one or more of filter 130, each filter 130 having one or more of filter attribute 132. Filter 130 may be analogous to field 126 for action 118 and may vary according to the type of trigger 120.

Turning back to FIG. 1A, workflow builder 100 includes one or more user interfaces (UIs), such as a configure-UI 134, which may be presented on a computing device (not shown). A user 136, such as an application developer, may interact with configure-UI 134 to configure workflow-object 116. In various examples, configure-UI 134 provides preconfigured workflow-objects 116 that are relevant to a context of the tiered software framework. Consider, for example, that the context of tiered software framework is focused on marketing. Consequently, a substantial portion of preconfigured workflow-objects 116 have functionalities tailored for marketing activities, such as survey generation, webpage designs, funnels, emails, advertisements, brand campaigns, social media posts, etc. An entirely different context, such as an application for financial operations, may be generated in such workflow builder 100, but may require more software knowledge to develop the appropriate custom script for workflows tailored to generate and operate on worksheets, balance sheets, stock trading, etc.

Configure-UI 134 enables definitions of field attribute 128 of field 126 and filter attribute 132 of filter 130 using custom scripts (e.g., Javascript, Python, C++, etc.) or preconfigured UI elements. Examples of preconfigured UI elements include forms with input controls such as buttons (e.g., “save” button, “cancel” button, “edit” button, “add” button, etc.), text areas (e.g., to input complex logic and calculations, descriptions, etc.), checkbox, radio buttons, drop down menu, selection bars, date pickers, etc. ; navigation controls such as navigation bar, sidebar, tabs, etc. ; informational elements, such as tooltips, popups, badges, etc. ; containers, such as cards, accordions, grids, etc. ; links; and so forth. In some examples, field attributes 128 or filter attributes 132 of preconfigured workflow-object 116 are changed suitably by user 136 according to particular needs. In yet other examples, additional preconfigured fields 126 or filters 130 are added to preconfigured workflow-objects 116 suitably by user 136 based on particular needs. In yet other examples, new fields 126 or filters 130 are generated by user 136 using custom scripts or preconfigured UI elements. In some examples, configure-UI 134 enables user 136 to connect to external APIs to configure workflow-objects 116.

Workflow builder 100 further includes a build-UI 138 to enable user 136 to build workflow 114 with workflow-objects 116 and define various ones of dependency 122 suitably. Build-UI 138 provides a layout comprising a visual mapping of interconnected workflow-objects 116 representing workflow 114. A selection of workflow-objects 116 configured in configure-UI 134 are displayed in build-UI 138 appropriately so that user 136 can select desired workflow-objects 116 from the selection and add selected workflow-objects 116 to the layout. In some examples, the selection includes preconfigured workflow-objects 116, workflow-objects 116 configured in configure-UI 134, workflow-objects 116 purchased from others, or workflow-objects 116 shared from another account. In some examples, build-UI 138 enables user 136 to drag and drop configured ones of workflow-objects 116 while specifying their dependency 122. In various examples, configure-UI 134 and build-UI 138 enables building of application 112, workflow 114 or workflow-object 116 using a no-code or low-code approach.

The configurations of workflow-objects 116 from configure-UI 134 and the layout of workflow 114 from build-UI 138 are converted into metadata 124 through API 140. API 140 functions as an execution layer that handles storing, retrieving, and orchestrating of workflow 114. In some examples, portions of workflow builder 100, for example, portions of configure-UI 134, build-UI 138 and prewritten object code 144, may be provisioned in third-party no-code builders (e.g., Bldr™, Bubble™, etc.) communicating with the other components of workflow builder 100 through API 140. Metadata 124 is stored in a metadata database 142 in first-tier WB module 106-1. During execution of workflow 114, metadata 124 is retrieved from metadata database 142 through API 140 by prewritten object code 144 and used suitably to perform the configured functions according to the dependencies. A deployment engine 146 facilitates generating a suitable environment (e.g., sandbox, production, etc.) to execute various ones of application 112, workflow 114 and/or workflow-object 116. A reviewer module 148 facilitates reviewing of application 112, workflow 114, and/or workflow-object 116 before deployment.

Workflow builder 100 differs from generic no-code or low-code application builders in many ways. For example, workflow builder 100 facilitates easy build of those applications 112 or workflows 114 that are relevant to the context of tiered software framework. In some such examples, some of actions 118 and triggers 120 are preconfigured according to the context; and other ones can be modified from the preconfigured versions. Prewritten object code 144 in such examples includes various context-driven operations accordingly. Other applications or workflows that are not relevant to the context can be built but may require more skill or programming knowledge, as prewritten object code 144 for such context-independent operations may not be available natively in first-tier WB module 106-1. This structure makes for increased efficiency compared to generic no-code or low-code application builders, providing an improvement in the associated computer technology (e.g., in terms of memory utilization, speed of building application 112, etc.).

Workflow builder 100 also differs from other generic no-code or low-code application builders in facilitating a multi-tiered approach. Typically, some enterprises may design their own custom no-code builder tailored for their specific business goals; however, access to such a builder is restricted to their own employees or agents. In such a builder, all data is available for all users. Some companies may deploy a custom no-code or low-code application builder for a specific market; however, access to such a builder is restricted to their customers at a single tier. In such a builder, data is siloed within each customer's account so that one customer cannot access another customer's data except through a common shared portal, such as marketplace 150, in which access is manually specified. On the other hand, the multi-tiered framework of workflow builder 100, in which functionalities and data are distributed across a plurality of tiers enables efficient and secure implementation of privacy policies and data protection, while permitting data flows for approved hierarchies across tiers within the framework. This framework allows subscribers 104 to generate custom ones of application 112, workflow 114 and/or workflow-object 116 tailored for their respective downstream subscribers 104 while utilizing the marketplace functionality for sharing with others outside their approved data hierarchy. In some examples, sharing is based on preconfigured settings, such as subscription plans of downstream subscribers, so that no manual intervention is needed to share any of application 112, workflow 114 and/or workflow-object 116 with other end-users. This facilitates cybersecurity and data privacy that are important in the functioning of networked computers. Note that these enumerated differences are merely a few of the various other ways in which workflow builder 100 differs from other workflow builders.

Application 112, workflow 114 and/or workflow-object 116 may be made available for sharing on a marketplace 150 in marketplace platform 110. Marketplace 150 is a digital market comprising a user interface with underlying software infrastructure to facilitate exchange of products and services. Unlike traditional e-commerce sites that sell their own products, marketplace 150 acts as an intermediary, providing tools for multiple third-party sellers to create online storefronts and reach a broad customer base. Any subscriber 104 may offer application 112, workflow 114, and workflow-object 116 on marketplace 150 according to their subscription terms; likewise, any subscriber 104 may buy application 112, workflow 114 and workflow-object 116 on marketplace 150 according to their subscription terms. Any product or service, including application 112, workflow 114 and workflow-object 116 may be shared on marketplace 150 according to marketplace terms specified by the seller.

In some examples, user 136 has access credentials of one of first-tier subscribers 104-1. In some other examples, user 136 has access credentials of one of second-tier subscribers 104-2. In yet other examples, user 136 has access credentials of one of third-tier subscribers 104-3. Assume that in one example scenario, user 136 has access credentials of one of second-tier subscribers 104-2, say “agency 1”, whose account is subscribed to by certain third-tier subscribers 104-3, say “brands 1”. User 136 builds workflow 114 using configure-UI 134 and build-UI 138. Various information of second-tier subscriber 104-2 including tier information, subscriber information, marketplace terms and subscription terms are saved as settings 152 in second-tier WB module 106-2. Settings 152 may specify that workflow 114 is to be published to marketplace 150 under certain marketplace terms, such as price, restrictions, etc. Thereupon, a push module 154 in second-tier WB module 106-2 pushes workflow 114 to marketplace 150 in marketplace platform 110. In some examples, the publishing is automatic; in other examples, the publishing is manual; such automatic or manual publishing may be specified in settings 152. In various examples, such workflow 114 and workflow-object 116 are available to any subscriber 104 in any tier 102 according to the marketplace terms. In other words, second-tier subscribers 104-2 (e.g., agencies other than agency 1 ) and third-tier subscribers 104-3 who are not subscribers of the user's second-tier account (e.g., brands other than brands 1 ) can access the shared workflows 114 and workflow-objects 116 by purchasing them in marketplace 150.

User 136 may also share workflow 114 outside marketplace 150 to third-tier subscribers 104-3 of the user's account (i.e., brands 1 ) by pushing workflow 114 to such accounts using push module 154 according to the relevant subscription terms. Such a scenario may be applicable in cases where the subscription plan of brands 1 includes access to workflow 114; or the subscription fees for access to workflow 114 has been paid by brands 1 ; or as a bonus feature free to all of brands 1 ; etc. In various examples, push module 154 is also configured to push updates of workflow 114 in real time to various instances thereof in the tiered software framework. In some such examples, push module 154 identifies that user 136 has access credentials of one of second-tier subscribers 104-2, and brand 1 is subscribed thereto. Responsive to identifying that the user's account belongs to one of the upstream tiers 102, and brand 1 from one of the downstream tiers 102 is subscribed thereto, push module 154 pushes workflow 114 and workflow-object 116 to brand 1's account, so that workflow 114 and workflow-object 116 are available to brand 1 according to the subscription terms stored in the user's account. In some examples, the publishing to brand 1's account is automatic; in other examples, the publishing is manual; such automatic or manual publishing may be specified in settings 152.

In various examples, the functionalities of push module 154 are based upon the particular tier 102 with which it is associated. For example, an instance of push module 154 provisioned in second-tier WB module 106-2 can push workflow 114 and workflow-object 116 to marketplace 150 and to other downstream third-tier subscribers 104-3. On the other hand, another instance of push module 154 provisioned in third-tier WB module 106-3 can push workflow 114 and workflow-object 116 only to marketplace 150 but not to other subscribers 104. In various examples, such provisioning may be based on the access credentials of user 136 accessing push module 154. In some such examples, a central push module 154 may allow user 136 with access credentials of one of second-tier subscribers 104-2 to push workflow 114 to marketplace 150 and to third-tier subscribers 104-3; on the other hand, the same central push module 154 may allow user 136 with access credentials of one of third-tier subscribers 104-3 to push workflow 114 only to marketplace 150 but not to other subscribers 104. Note that in the example illustration, push module 154 is shown provisioned in second-tier WB module 106-2 merely for explanation and not as a limitation. In various examples, second-tier WB module 106-2 and third-tier WB module 106-3 may be substantially identical in terms of modules provisioned therein, except that the data and functionalities therein are associated with the respective tiers 102.

After application 112, workflow 114, and/or workflow-object 116 have been deployed in production, they may be executed by one or more of an end-user 160, who has access credentials at one of second tier 102-2 or third tier 102-3. For example, if workflow 114 is suited to a marketing agency (e.g., workflow for creating a funnel), end-user 160 may have access credential at second tier 102-2; on the other hand, if workflow 114 is suited to a brand (e.g., generating customer surveys), end-user 160 may have access credential at third tier 102-3 or second tier 102-2.

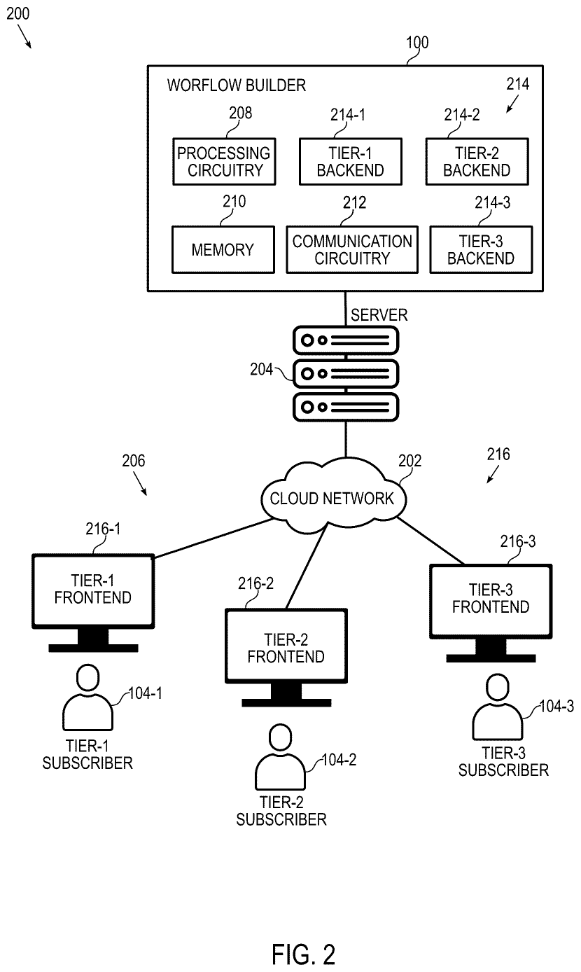

FIG. 2 is a simplified block diagram illustrating a tiered software framework 200 according to various embodiments. In example implementations, at least some portions of the activities outlined herein may be hosted on a cloud network 202 in one or more servers 204. At least some other portions of the activities outlined herein may be implemented in one or more computing devices 206 connected over one or more communication networks with cloud network 202. In particular embodiments, cloud network 202 is a collection of hardware devices and executable software forming a shared pool of configurable computing resources (e.g., networks, servers, storage, applications, services, etc.) that may be suitably provisioned to provide on-demand self-service, network access, resource pooling, elasticity and measured service, among other features. Computing device 206 may have any desired form factor, such as a handheld or mobile computing device (e.g., a cell phone, a smart phone, a mobile Internet device, a tablet computer, a laptop computer, a netbook computer, an ultra-book computer, a Personal Digital Assistant (PDA), an ultramobile personal computer, etc.), a desktop computing device, a server or other networked computing component, a set-top box, an entertainment control unit, or a wearable computing device.

Certain portions of tiered software framework 200 (e.g., workflow builder 100) may execute using a processing circuitry 208, a memory 210 and communication circuitry 212 (among other components) in one or more servers 204. Certain other portions of tiered software framework 200 may execute in one or more computing devices 206 using respective processing circuitry, memory, and communication circuitry (not shown with particularity so as not to clutter the drawing) substantially similar in functionalities to processing circuitry 208, memory 210 and communication circuitry 212. In some embodiments, one or more of these features may be implemented in hardware, provided external to these elements, or consolidated in any appropriate manner to achieve the intended functionality. The various network elements in tiered software framework 200 may include communication software that can coordinate to achieve the operations as outlined herein. In still other embodiments, these elements may include any suitable algorithms, hardware, software, components, modules, interfaces, or objects that facilitate the operations thereof.

Processing circuitry 208 may execute any type of instructions associated with data stored in memory 210 to achieve the operations detailed herein. In one example, processing circuitry 208 may transform data from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., field programmable gate array (FPGA), an erasable programmable read only memory (EPROM), an application specific integrated circuit (ASIC)) that includes digital logic, software, code, electronic instructions, flash memory, optical disks, magnetic or optical cards, other types of machine-readable mediums suitable for storing electronic instructions, or any suitable combination thereof.

In some of example embodiments, one or more memory 210 may store data used for the operations described herein. This includes memory 210 storing instructions (e.g., software, logic, code, etc.) in non-transitory media (e.g., random access memory (RAM), read only memory (ROM), FPGA, EPROM, etc.) such that the instructions are executed to carry out the activities described in this disclosure based on particular needs. In some embodiments, memory 210 may comprise non-transitory computer-readable media, including one or more memory devices such as volatile memory such as dynamic RAM (DRAM), nonvolatile memory (e.g., ROM), flash memory, solid-state memory, and/or a hard drive. In some embodiments, memory 210 may share a die with processing circuitry 208. Memory 210 may include algorithms, code, software modules, and applications, which may be executed by processing circuitry 208. The data being tracked, sent, received, or stored in tiered software framework 200 may be provided in any database, register, table, cache, queue, control list, or storage structure, based on particular needs and implementations, all of which could be referenced in any suitable timeframe.

Communication circuitry 212 may be configured for managing wired or wireless communications for the transfer of data in tiered software framework 200. The term “wireless” and its derivatives may be used to describe circuits, devices, systems, methods, techniques, communications channels, etc., that may communicate data through modulated electromagnetic radiation in a nonsolid medium. The term does not imply that the associated devices do not contain any wires, although in some embodiments they might not. Communication circuitry 212 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long Term Evolution (LTE) project along with any amendments, updates, and/or revisions (e.g., advanced LTE project, ultramobile broadband (UMB) project (also referred to as “3GPP2”), etc.). Communication circuitry 212 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. Communication circuitry 212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication circuitry 212 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication circuitry 212 may operate in accordance with other wireless protocols in other embodiments. Communication circuitry 212 may include antennas to facilitate wireless communications and/or to receive other wireless communications.

In some embodiments, communication circuitry 212 may manage wired communications, such as electrical, optical, or any other suitable communication protocols (e.g., the Ethernet, Internet). Communication circuitry 212 may include multiple communication chips. For instance, a first communication chip may be dedicated to shorter-range wireless communications such as Wi-Fi or Bluetooth, and a second communication chip may be dedicated to longer-range wireless communications such as global positioning system (GPS), EDGE, GPRS, CDMA, WiMAX, LTE, EV-DO, or others. In some embodiments, a first communication chip may be dedicated to wireless communications, and a second communication chip may be dedicated to wired communications.

The example network environment may be configured over a physical infrastructure that may include one or more networks and, further, may be configured in any form including, but not limited to, local area networks (LANs), wireless local area networks (WLANs), virtual local area networks (VLANs), metropolitan area networks (MANs), wide area networks (WANs), virtual private networks (VPNs), Intranet, Extranet, any other appropriate architecture or system, or any combination thereof that facilitates communications in a network. In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a WANs (e.g., the Internet).

In various embodiments, tiers 102 may be partitioned into a backend 214 and a frontend 216. Backend 214 may comprise tier-1 backend 214-1, tier-2 backend 214-2, and tier-3 backend 214-3 provisioned in one or more servers 204. Likewise, frontend 216 may comprise tier-1 frontend 216-1, tier-2 frontend 216-2, and tier-3 frontend 216-3 provisioned in one or more computing devices 206. Backend 214 may comprise various modules, logic, software engines and other components that are distributed (and common) across all users of tiered software framework 200. Backend 214 may execute operations for managing and processing data, performing computations, and facilitating communication between different components, such as components of workflow builder 100. In particular embodiments, backend 214 may include operations such as data management, business logic of workflow builder 100, user authentication and authorization, security and validation, APIs with third-party components such as web crawlers, payment processors, etc.

In a general sense, frontend 216 comprises at least a user interface, including configure-UI 134 and build-UI 138, using which human users interact with tiered software framework 200. Frontend 216 may also include libraries, forms, device integrators and other components as desired and based on particular needs. Frontend 216 may be presented on a suitable display device coupled to computing device 206 and appropriate to show visual indicators, such as a heads-up display, a computer monitor, a projector, a touchscreen display, a liquid crystal display (LCD), a light-emitting diode display, and/or a flat panel display. In various embodiments, frontend 216 may be specific to the particular one of tier 102. For example, frontend 216-1 at first tier 102-1 may comprise certain functionalities available (and visible) only to first-tier subscriber 104-1, e.g., SaaS provider, software developer. Frontend 216-2 at second tier 102-2 may comprise certain functionalities available (and visible) only to second-tier subscriber 104-2. Frontend 216-3 at third tier 102-3 may comprise certain functionalities available (and visible) only to third-tier subscriber 104-3.

Tiered software framework 200 described and shown herein (and/or its associated structures) may also include suitable interfaces for receiving, transmitting, and/or otherwise communicating data or information in a network environment. In a general sense, the arrangements depicted in the figures may be more logical in their representations, whereas a physical architecture may include various permutations, combinations, and/or hybrids of these elements. It is imperative to note that countless possible configurations can be used to achieve the operational objectives outlined here. Accordingly, the associated infrastructure has a myriad of substitute arrangements, design choices, device possibilities, hardware configurations, software implementations, equipment options, etc.

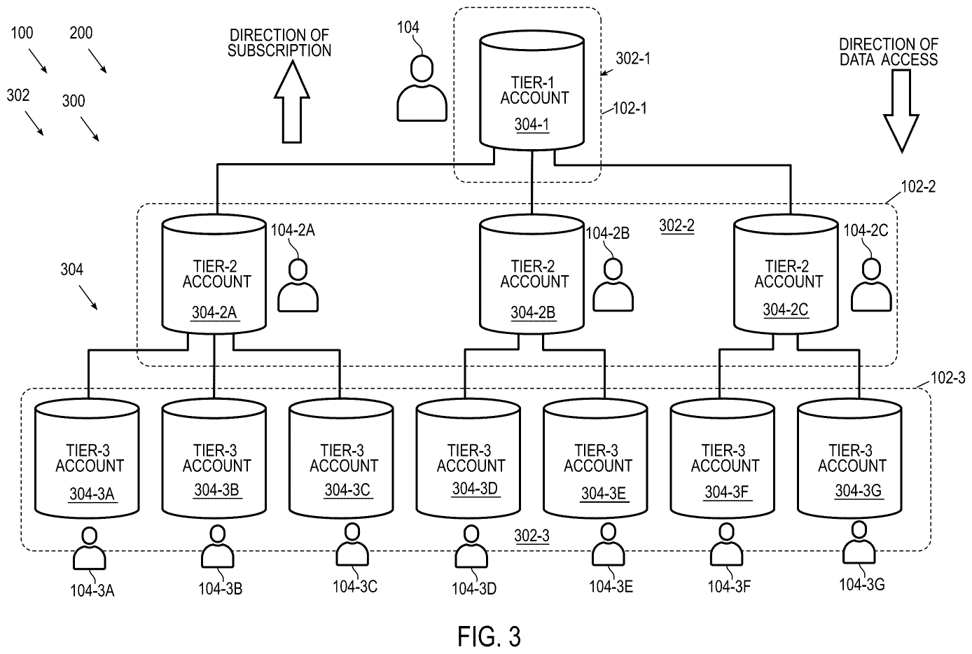

FIG. 3 is a simplified block diagram illustrating example details of data hierarchy 300 of tiered software framework 200 implementing workflow builder 100, according to some embodiments of the present disclosure. In various embodiments, data 302 communicated in tiered software framework 200 may be exclusively received from users such as subscriber 104-1 and subscribers 104-2, and 104-3; in some other embodiments, data 302 may also be received from other sources, such as third parties and/or from the Internet. Examples of data 302 include business niche targeted by subscribers 104, marketing activities such as on social media, target audience of subscribers 104, login credentials to access various marketing platforms, frequency of marketing activities, information to be included in the content of marketing posts, customer lists, business locations, marketing platform rules, and other such data relevant to the functionalities offered by tiered software framework 200. Data 302 may be stored in data lakes, databases, data warehouses, blockchains, file systems and other types of data storage facilities within the broad scope of the embodiments with corresponding accessing and viewing capabilities as described herein.

Data 302 in each tier 102 may be contained within accounts 304 accessible and viewable with appropriate access credentials. For example, account 304-1 may be associated with subscriber 104-1. Account 304-1 may manage a plurality of accounts 304-2 at tier 102-2. Subscriber 104-2A may have a subscription to account 304-2A in plurality of accounts 304-2. Account 304-2A may manage a plurality of accounts 304-3 at tier 102-3. Subscriber 104-3A may have a subscription to account 304-3A in plurality of accounts 304-3; subscriber 104-3B may have a subscription to account 304-3B in plurality of accounts 304-3; and subscriber 104-3C may have a subscription to account 304-3C in plurality of accounts 304-3. In other words, subscriber 104-2A has three downstream subscribers at tier 102-3, namely subscribers 104-3A, 104-3B, and 104-3C with their associated respective accounts 304-3A, 304-3B, and 304-3C. Likewise for other accounts shown in the figure. Note that such a framework is merely provided for illustrative purposes and should not be construed as a limitation. Any number of subscribers may be provided at tiers 102-2 and 102-3 in tiered software framework 200 within the broad scope of the embodiments.

In various embodiments, data 302 may be arranged in data hierarchy 300 for different accounts 304 such that certain users can view and access only a subset of data 302 according to their respective tier 102 and access credentials based on particular needs (e.g., user credentials may indicate which tier 102 and which corresponding accounts 304 are available for access and view). Such accounts 304 may be facilitated by a suitable user interface at frontend 216 for viewing the accessible data. Appropriate user authentication and authorization engines running in backend 214 may ensure that accounts 304 are maintained as desired and appropriate privacy blocks are applied at appropriate tiers 102.

In the example illustrated herein, tier-1 data 302-1 may be of account 304-1; tier-2 data 302-2 may be of accounts 304-2A, 304-2B and 304-2C corresponding to subscribers 104-2A, 104-2B and 104-2C, respectively; tier-3 data 302-3 may be of accounts 304-3A . . . 304-3G corresponding to subscribers 104-3A . . . 104-3G. Subscribers 104-3A . . . 104-3G may access and view their own respective accounts 304-3A . . . 304-3G; however, they cannot access or view other accounts 304 in the same tier 102-3 or in upstream tiers 102-2 or 102-1. Note that accessing and viewing an account refers to accessing and viewing the data of the account. Subscribers 104-2A . . . 104-2C at tier 102-3 may access and view their own respective accounts 304-2A . . . 304-2C as well as downstream accounts 304-3 of their respective subscribers 104-3; however, they cannot access or view other accounts 304-2 in the same tier 102-2, or in downstream tier 102-3 not associated with their downstream subscribers 104-3, or in upstream tier 102-1. For example, subscriber 104-2A may access and view accounts 304-2A, 304-3A, 304-3B, and 304-3C; subscriber 104-2B may access and view accounts 304-2B, 304-3D, and 304-3E; subscriber 104-2C may access and view accounts 304-2C, 304-3F, and 304-3G. Subscriber 104-1 at tier 102-1 may access and view accounts 304-1 at tier 102-1, 304-2A . . . 304-2C at tier 102-2, and 304-3A . . . 304-3G at tier 102-3.

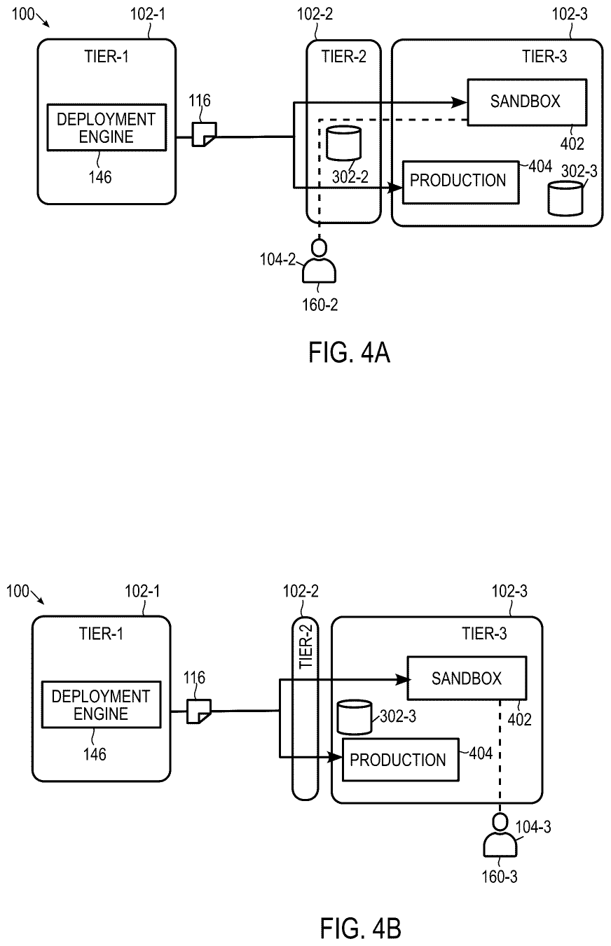

FIGS. 4A and 4B are simplified block diagrams illustrating certain details of an example workflow builder 100. Deployment engine 146 may deploy workflow-object 116 of workflow 114 to a sandbox 402 or to a production 404, depending on configurations thereof. In some examples, responsive to identifying workflow-object 116 as confirmed (e.g., safe, secure, native, qualified, prior tested and passed, etc.), deployment engine 146 sends workflow-object 116 to production 404 for execution. On the other hand, responsive to identifying workflow-object 116 as unconfirmed (e.g., unsafe, unsecured, untested, configurations changed from preconfigured settings, entirely new type of action, etc.) deployment engine 146 sends workflow-object 116 to sandbox 402 for execution. Thus, deployment engine 146 ensures that injecting custom code, such as custom configurations of workflow-object 116, into tiered software framework 200 does not negatively impact tiered software framework 200 or various applications 112 running on tiered software framework 200.

Sandbox 402 facilitates executing workflow-object 116 in a secure environment that is isolated from production 404 where other parts of tiered software framework 200 execute. Sandbox 402 remains segregated from production 404 through various means. For example, memory registers of sandbox 402 are abstracted and managed through the operating system or container runtime, preventing direct access to system-level memory or registers of production 404. Access controls, namespaces, and other parameters limit resource usage and visibility to sandbox 402, while system calls to production 404 are filtered through API 140 to prevent unsafe operations. Safety is ensured by combining these isolation techniques with strict network policies, filesystem mount restrictions (e.g., read-only or ephemeral storage), and constant monitoring. Any breach or anomaly in sandbox 402 can be detected and contained without compromising the integrity or security of production 404. In various examples, code associated with workflow 114 is compiled in sandbox 402 before execution of workflow 114 therein.

In various examples, workflow-object 116 executing in sandbox 402 cannot modify parameters and variables of other actions, workflows or applications in tiered software framework 200 that are not concurrently executing in the same environment. Sandbox 402 isolates and safely runs third-party or custom actions that are not native to tiered software framework 200, such as workflow-object 116 created by user 136 with unknown safety credentials (e.g., not verified, not authenticated, etc.), workflow-object 116 imported or called into tiered software framework 200 from external applications, workflow-object 116 that are not vetted by tiered software framework 200, etc. Additionally, sandbox 402 supports additional monitoring and logging than is available in production 404, enabling detailed analysis of behaviors, outcomes, or errors of workflow 114. Sandbox 402 prevents malicious or unstable code from affecting tiered software framework 200 in various examples. In various examples, the boundaries of sandbox 402, including permitted API calls and network access, are set at tier 102-1, so that users 136 or end-users 160 cannot modify them to gain unauthorized access to other parts of tiered software framework 200.

Note that sandbox 402 is not merely a testing environment; it is used during live production execution of action 118 using actual user data (and not test data). Note also that sandbox 402 is different from a container, the latter being a standalone executable package that includes everything needed to run a piece of software (e.g., code, runtime, libraries, and dependencies) using operating system (OS) level virtualization. While the container has OS level process isolation, sandbox 402 has code-level, API restrictions. In other words, sandbox 402 comprises a restricted execution space with access to a limited set of calls to API 140, whereas production 404 comprises an unrestricted execution space with access to more than the limited set of calls to API 140. Thus, executing in sandbox 402 ensures that workflow-object 116 cannot leak data (e.g., by writing to the file system of application 112 that called workflow-object 116 or other applications in tiered software framework 200). Executing workflow-object 116 in sandbox 402 also ensures that the custom code cannot crash the system or consume excessive resources and that security boundaries are enforced.

On the other hand, production 404 is an execution environment that is not isolated like sandbox 402. In production 404, all features, workflows, and data are fully functional and publicly available according to the respective access credentials of end-users 160. Actions 118 executing in production 404 can access all functions and calls of API 140. Actions 118 executing in production 404 can modify parameters and variables that are used by other actions, workflows or applications in tiered software framework 200, for example, by writing to memory registers of other actions, workflows or applications. In some examples, some actions of workflow 114 execute in sandbox 402 and other actions of workflow 114 execute in production 404. In some other examples, all actions of workflow 114 execute in sandbox 402. Deployment engine 146 determines which environment is appropriate for any action 118 before execution and then assigns the execution to the appropriate environment.

Assume, for example, that a third-party application needs an action result from workflow 114 in order to complete execution. Workflow 114 executes in sandbox 402 so that the third-party application cannot simply call workflow 114 within its execution environment; instead, it must request sandbox 402 for the action result through an appropriate API call and wait for the action result therefrom. Likewise, the third-party application cannot inject itself into workflow 114 (e.g., by writing to the memory register of workflow 114) because it executes in a separate environment. Similarly, workflow 114 executing in sandbox 402 cannot modify any variables or write to any memory register of the third-party application executing in production 404.

In some examples (as shown), sandbox 402 and production 404 execute at third tier 102-3. In some other examples, sandbox 402 and production 404 execute at second tier 102-2 also. Second-tier end-users 160-2 access sandbox 402 or production 404 through second tier 102-2 using access credentials of second-tier subscribers 104-2; third-tier end-users 160-3 access production 404 through third tier 102-3 using access credentials of third-tier subscribers 104-3. In various examples, such tier-based accessibility may not need to be programmed into workflow 114; however, workflow builder 100 automatically ensures that data and features are accessible to end-users 160 according to their specific tier. In the example shown in FIG. 4A, second-tier end-user 160-2 has access credentials of one of second-tier subscribers 104-2. Hence, workflow 114 may be executed in sandbox 402 using second-tier data 302-2 or third tier data 302-3 to which end-user 160-2 has access. In the example shown in FIG. 4B, third tier end-user 160-3 has access credentials of one of third-tier subscribers 104-3. Thus, workflow 114 may be executed in sandbox 402 using only third tier data 302-3 to which end-user 160-3 has access.

In various examples, deployment engine 146 handles the tier location and accessibility to sandbox 402 and/or production 404 in the background without intervention by user 136 or end-user 160. Thus, user 136 accessing sandbox 402 or second-tier end-user 160-2 accessing production 404 at second tier 102-2 need not specify that second-tier data 302-2 may be used unless data access is to be restricted to downstream tier locations per workflow logic. In some examples, functionalities (e.g., third-party applications, actions, etc.) that are available only to second-tier subscribers 104-2 may be made available for inclusion in workflow 114 during build irrespective of the tier location of execution. Thereafter, during execution, access to data and functionalities are suitably controlled by tiered software framework 200. For example, user 136 accessing sandbox 402 or third-tier end-user 160-3 accessing production 404 with access credentials of one of third-tier subscribers 104-3 will not have access to functionalities or data of workflow 114 that are only available at second tier 102-2.

In one specific example, assume that tiered software framework 200 allows access to user logs only at first tier 102-1 or second tier 102-2 but not at third tier 102-3. Assume also that workflow 114 includes an action allowing end-user 160 to view user logs. When building workflow 114, user 136 does not have to configure the action to deny access to end-users at third tier 102-3. Such denial of access is automatically implemented by tiered software framework 200 during execution. Consequently, the same workflow 114 has different functionalities accessible to end-users 160 based on their respective access credentials: second-tier end-users 160-2 can see user logs in workflow 114, whereas third-tier end-users 160-3 cannot see user logs in workflow 114.

During operation, API 140 receives instructions from a third-party application to execute workflow 114. Responsive to receiving the instructions, API 140 retrieves metadata 124 of workflow 114. Deployment engine 146 identifies that a portion of workflow 114 is unconfirmed (e.g., certain ones of workflow-objects 116 are unconfirmed, or one more of dependency 122 is unconfirmed, etc.) whereas another portion is confirmed (e.g., contains only safe, qualified workflow-objects 116). Responsive thereto, deployment engine 146 provisions sandbox 402 isolated from other concurrently executing workflows in tiered software framework 200. Deployment engine 146 thereafter executes workflow 114 thus: for each workflow-object 116, deployment engine 146 sends workflow-object 116 to sandbox 402 for execution through API 140. Sandbox 402 responds immediately after execution is completed indicating a status of the execution as successful or unsuccessful. Responsive to identifying the status as successful, API 140 stores a result of the execution for later retrieval. On the other hand, responsive to identifying workflow-object 116 as confirmed, deployment engine 146 sends workflow-object 116 to production 404 for execution. API 140 proceeds to the next workflow-object 116 according to dependency 122 specified in metadata 124 of workflow 114 and continues until all workflow-object 116 of workflow 114 complete execution.

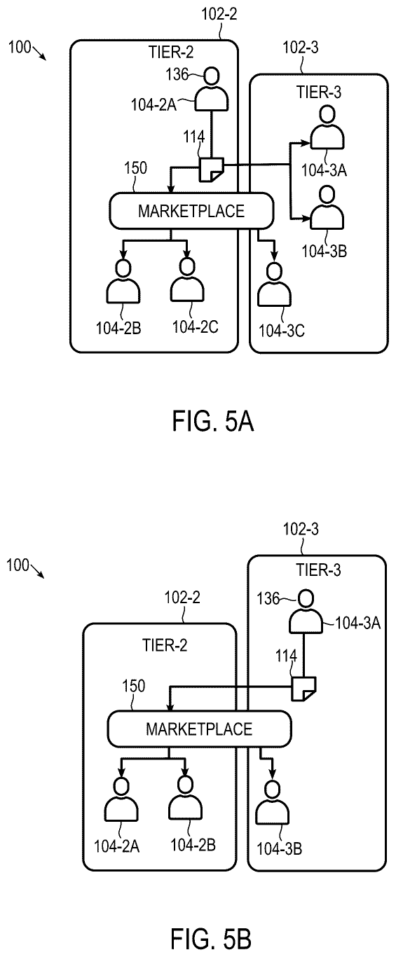

FIGS. 5A and 5B are simplified block diagrams illustrating certain details of an example workflow builder 100. In the example shown in FIG. 5A, user 136 has access credentials of one of second-tier subscribers 104-2, say 104-2A, whose account is subscribed to by certain third-tier subscribers 104-3A and 104-3B. User 136 pushes workflow 114 to marketplace platform 110 (not shown) in marketplace 150 that is accessible at second tier 102-2 and third tier 102-3. When user 136 pushes workflow 114 to marketplace platform 110, workflow 114 is made visible and available (e.g., for purchase, download, import, sharing, etc.) to third parties (e.g., other subscribers of tiered software framework 200) in marketplace 150. User 136 may specify the pricing and other terms and conditions associated with sharing workflow 114 in marketplace 150. Thereafter, other second-tier subscribers 104-2, for example, 104-2B and 104-2C and other third-tier subscribers 104-3C may purchase or otherwise download workflow 114 from marketplace 150 according to the pricing and other terms and conditions as allowed by marketplace 150. Thereafter, such second-tier subscribers 104-2B and 104-2C and third-tier subscribers 104-3C may use workflow 114, create other workflows based on workflow 114, add workflow 114 to their applications, etc.

User 136 may also share workflow 114 outside marketplace 150 to third-tier subscribers 104-3A and 104-3B who are downstream subscribers of second-tier subscriber 104-2A by pushing workflow 114 to such accounts directly using push module 154. Such a scenario may be applicable in cases where the subscription plan of brands 1 includes access to workflow 114; or the subscription fees for access to workflow 114 has been paid by brands 1 ; or as a bonus feature free to all of brands 1 ; etc. In some such cases, subscriber 104-2A can offer discounts or other terms and conditions to their downstream subscribers than are not provided via marketplace 150. In the example shown in FIG. 5B, user 136 has access credentials of one of third-tier subscribers 104-3. As third-tier subscribers 104-3 do not have any downstream subscribers or any other subscribers in the same hierarchy level, user 136 can push workflow 114 only to marketplace 150. When user 136 pushes workflow 114 downstream to third-tier subscribers 104-3A and 104-3B, workflow 114 is immediately made visible and available for use in their respective UIs of marketplace platform 110. Thereafter, third-tier subscribers 104-3A and 104-3B may use workflow 114, create other workflows based on workflow 114, add workflow 114 to their applications, etc.

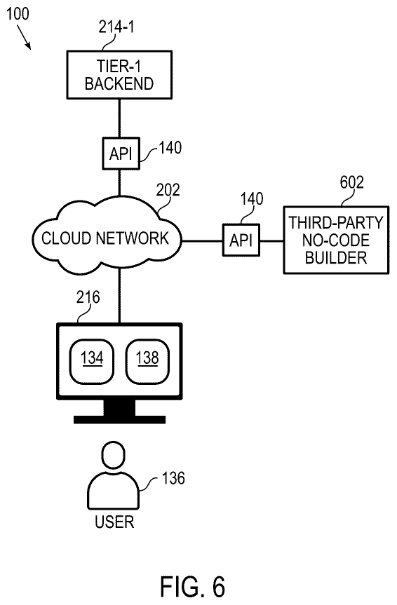

FIG. 6 is a simplified block diagram illustrating example details of workflow builder 100. Configure-UI 134 and/or build-UI 138 are presented to user 136 in frontend 216. Frontend 216 interfaces with first-tier backend 214-1 through API 140 over cloud network 202. Frontend 216 and first-tier backend 214-1 may also interface with one or more third-party no-code builder 602 via API 140 over cloud network 202. In some examples, any activity by user 136 on configure-UI 134 or build-UI 138 is converted in real time into appropriate metadata by third-party no-code builder 602 and stored by first-tier backend 214-1 in metadata database 142 of first-tier WB module 106-1. In some examples, some portions of prewritten object code 144 are in third-party no-code builder 602 and other portions thereof are in first-tier backend 214-1. API 140 functions as the execution layer that handles storing, retrieving, and orchestrating workflow actions, regardless of whether the action was created in workflow builder 100 within tiered software framework 200 or in third-party no-code builder 602, so that user 136 sees no difference at frontend 216 between operations executing in first-tier backend 214-1 and third-party no-code builder 602.

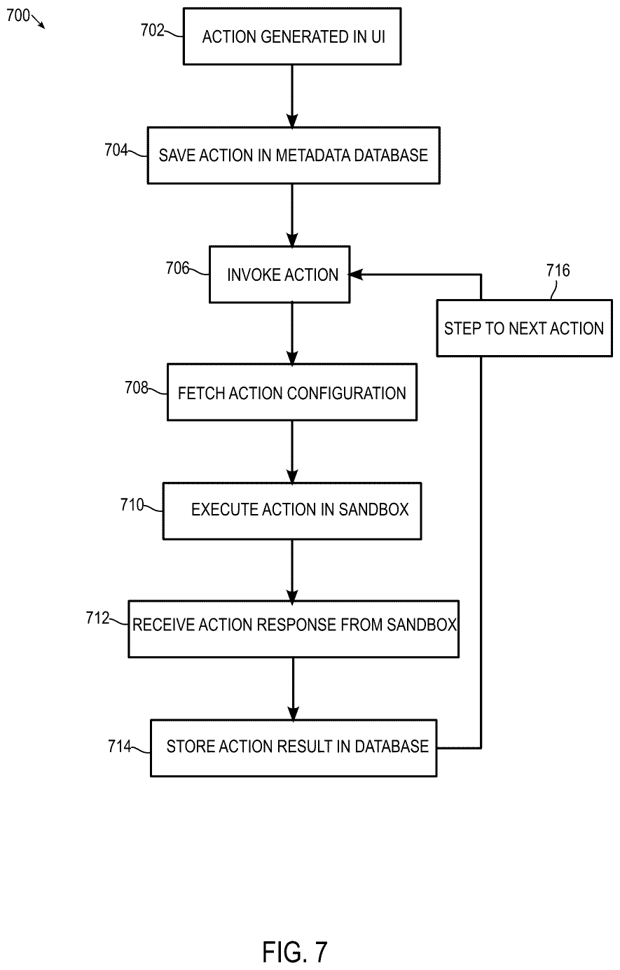

FIG. 7 is a simplified flow diagram illustrating example operations 700 associated with executing workflow 114 in sandbox 402. At 702, action 118 is generated in configure-UI 134 or build-UI 138. At 704, action 118 is saved in metadata database 142. At 706, action 118 is invoked, for example, by a process call from another action, trigger 120, etc. At 708, action configuration is fetched from metadata database 142. At 710, action 118 is executed in sandbox 402. At 712, action response of action 118 is received from sandbox 402. At 714, action result of action 118 is stored in metadata database 142. The operations step to next action 118 at 716, revert to step 706 and continue thereafter until all actions are executed and workflow 114 has finished executing. In various examples, the results stored in metadata database 142 may be reviewed and compared with expected results.

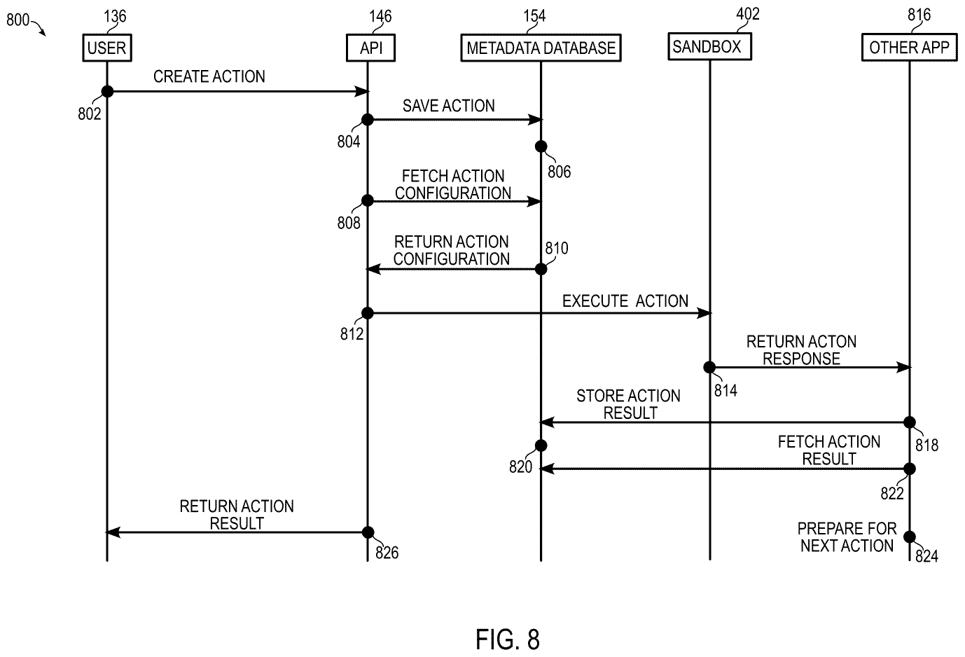

FIG. 8 is a simplified sequence diagram illustrating an example method 800 for building action 118 in workflow builder 100. At 802, user 136 creates action 118 using configure-UI 134 and adds it to workflow 114 using build-UI 138. At 804, API 140 receives action 118 and stores the action configuration as metadata 124 in metadata database 142. At 806, metadata database 142 acknowledges that metadata 124 of action 118 is successfully saved, ensuring that metadata 124 can be retrieved for later execution. During execution, workflow 114 of which action 118 is a part reaches the step in which action 118 is to be executed. Thereupon, at 808, API 140 instructs metadata database 142 to retrieve the action configuration stored as metadata 124. At 810, metadata database 142 returns the saved action configuration per the instruction. At 812, API 140 sends permission to execute action 118 according to the action configuration to in sandbox 402. At 814, action 118 is executed in 402, which returns an immediate response to a downstream action or event awaiting the action response. The downstream action or event can be part of workflow 114 (not shown) or a third-party application 816 (as shown). In some examples, the action response includes execution metadata (e.g., status code, runtime logs, basic confirmation, etc.) but may not necessarily include the final action result. Sandbox 402 ensures that action 118 is executed successfully in a controlled environment. In various examples, the response is provided from sandbox 402 to third-party application 816 through API 140, which is not shown in the figure for ease of illustration and so as not to clutter the drawing.

After execution is complete (i.e., third-party application 816 uses metadata 124 to process its internal action), at 818, API 140 causes third-party application 816 to send the final action result to be stored in metadata database 142. The action result contains data produced by action 118 (e.g., a newly generated record identifier, a calculated value, a response payload from an external API, etc.). At 820, metadata database 142 confirms that the action result has been stored. If a subsequent workflow step or third-party application 816 (as shown) needs the action result, at 822, a request may be made to metadata database 142 accordingly and API 140 retrieves the stored action result in response. In the example shown where workflow 114 involves third-party application 816, at 824, third-party application 816 subsequently prepares for the next action using the action result of the current action. At 826, which may be subsequent to, or concurrent with, 824, API 140 returns the action result to user 136 (or to first-tier WB module 106-1) for subsequent processing).

Assume, merely for example purposes, that action 118 is for generating a customer record in a customer record management system (CRM). The CRM comprises third-party application 816 in this example. At 802, user 136 may generate action 118 specifying that a form is to be generated, and the fields in the form are name, phone number, email address, and location. These action configurations are saved as metadata 124 in metadata database 142, and they are later fetched at 808 and 810 when action 118 is called by third-party application 816. At 812, API 140 instructs that action 118 is to be executed in sandbox 402. Upon execution, the action response comprises an empty form with the action configuration fields. This empty form is provided to the CRM at 814. The CRM fills in the necessary information (e.g., by a human user, automated agent, etc.) in the form and assigns a record identifier according to the business logic of the CRM. The filled form with the identifier comprises the action result, which is thereafter sent to and stored in metadata database 142 at 818 and 820. Certain portions of this action result may be fetched at 822, for example, when CRM requests the email address in the newly created record and prepares for sending an email with the returned email address. Finally, the filled form is returned to workflow 114 at 826, which may be a trigger for another event, such as for repeating execution of action 118 to generate another record.

Assume, merely for example purposes, that user 136 is an inexperienced programmer or a malicious hacker, and one of the fields in the action configuration is corrupted. For example, instead of associating the field with a local variable to be used only for action 118, user 136 has associated it with a global variable used by other applications in tiered software framework 200 so that executing the action would corrupt myriad other applications in tiered software framework 200. By executing action 118 in sandbox 402, the global variable is not affected; instead, only a limited copy of the global variable that is assigned to sandbox 402 is associated with the field, containing the action response to within the bounds of action 118, thereby minimizing any broader damage or fallout from the error.

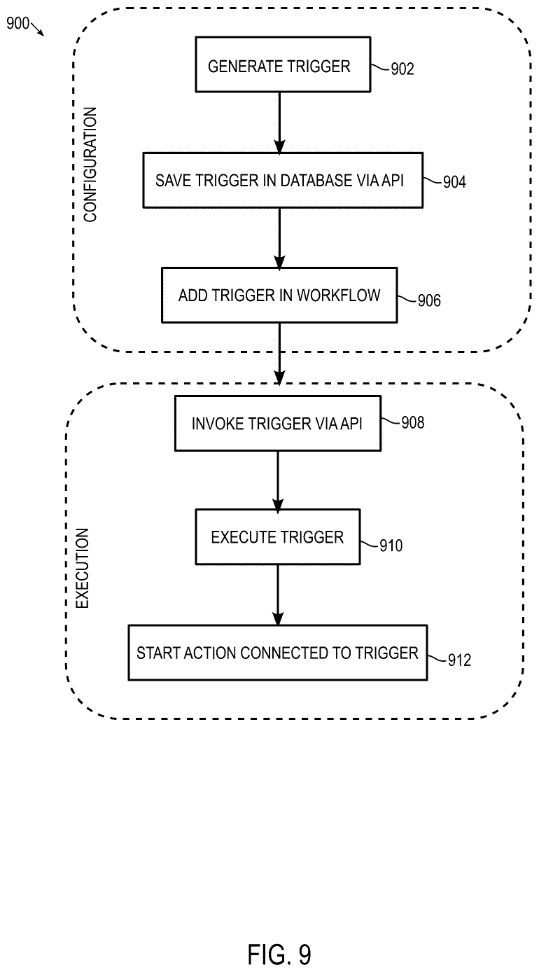

FIG. 9 is a simplified flow diagram illustrating an example method 900 for building triggers in workflow builder 100. At 902, trigger 120 is generated using configure-UI 134. At 904, trigger 120 is saved in metadata database 142 via API 140. At 906, first-tier WB module 106-1 adds trigger 120 to workflow 114 using build-UI 138. At 908, trigger 120 is invoked via API 140 during execution of workflow 114. For example, an action result causes an event associated with trigger 120 to occur. At 910, trigger 120 is executed. At 912, action 118 connected to trigger 120 is started. Note that steps 902-906 comprise configuration of trigger 120 (e.g., by user 136), whereas steps 910-914 comprise execution of trigger 120 in workflow 114 (e.g., by end-user 160).

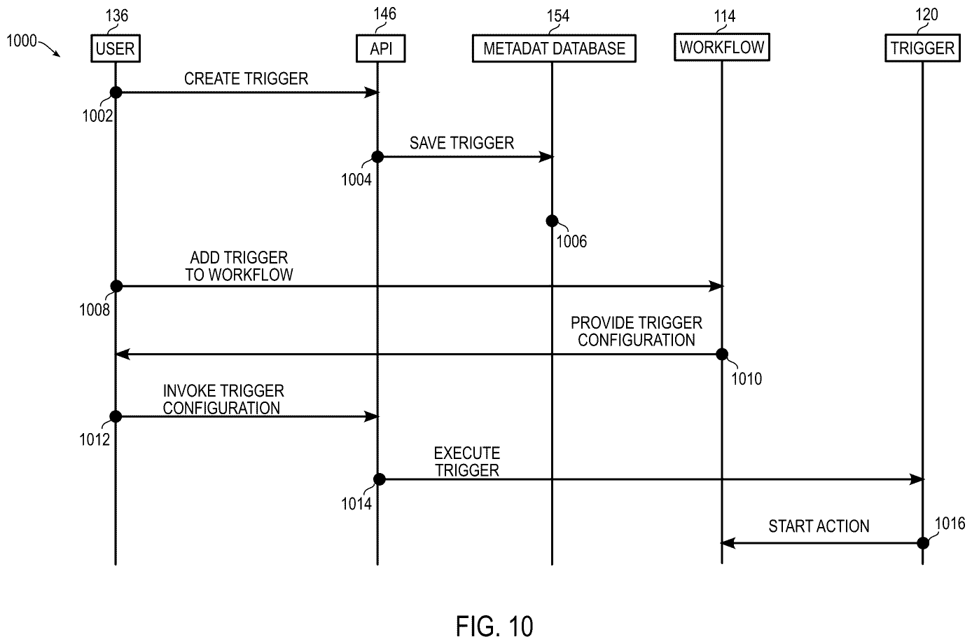

FIG. 10 is a simplified sequence diagram illustrating an example method 1000 for building triggers 120 in workflow builder 100. At 1002, trigger 120 is created by user 136 using configure-UI 134. At 1004, API 140 causes trigger 120 to be saved in metadata database 142 as metadata 124. At 1006, trigger 120 is saved in metadata database 142. At 1008, user 136 causes trigger 120 to be added to workflow 114 using build-UI 138. At 1010, workflow 114 returns the trigger configuration (e.g., relation to other ones of workflow-object 116) to user 136 (i.e., to first-tier WB module 106-1). During execution, at 1012, the trigger configuration is invoked. At 1014, API 140 causes trigger 120 to execute. At 1016, trigger 120 causes action 118 conditioned thereon to start executing.

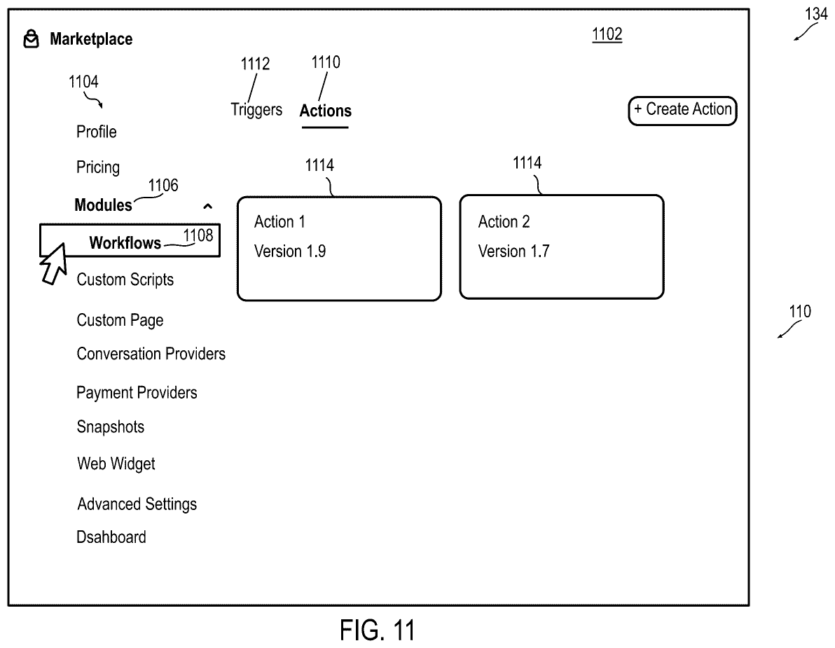

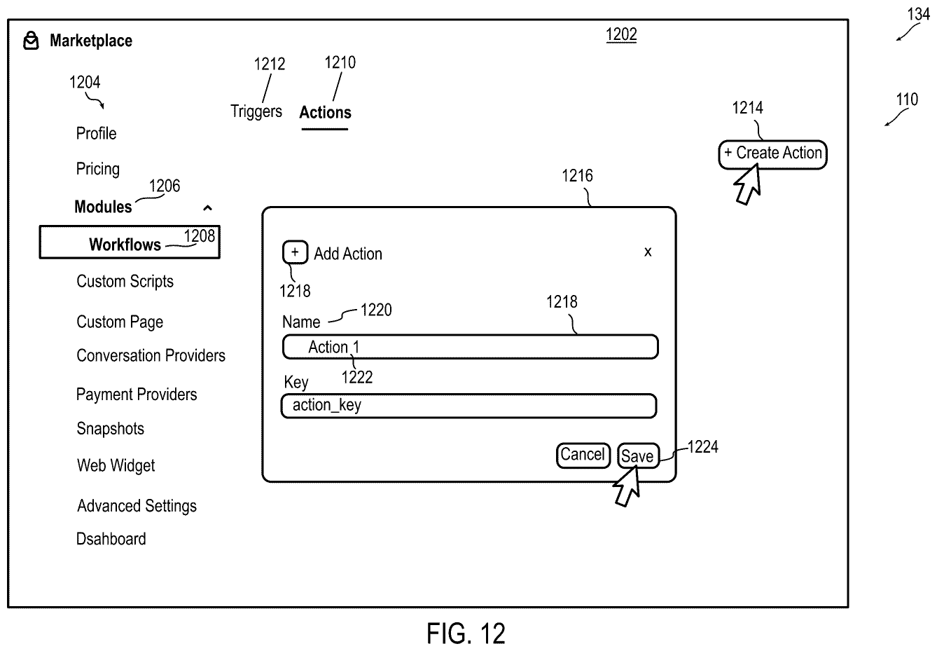

FIG. 11 is a simplified diagram illustrating an example configure-UI 134 for adding action 118 in workflow builder 100. A window 1102 is provided in configure-UI 134 to enable building workflow 114 suitably using various UI elements. In the example shown, window 1102 is enabled in a workspace associated with marketplace 150. In other words, user 136 accesses marketplace 150 and within the UI for marketplace 150, accesses window 1102. A menu 1104 is provided in window 1102 to access various selections applicable to features available in marketplace 150. For example, a selectable “modules” button 1106 is provided, which when selected, displays a selectable “workflows” button 1108. Selecting “workflows” button 1108, as indicated by the box and bold letters merely for ease of explanation and not as a limitation, causes display of a selectable “actions” button 1110 and a selectable “triggers” button 1112. In the view shown, “actions” button 1110 is selected (as indicated by bold letters merely for explanation and not as a limitation). Selecting “actions” button 1110 enables actions 118 to be generated and configured suitably using selectable boxes 1114. Each action 118 may be associated with a name and a key. A window to input the name and key may pop up when the button to add an action is pressed.

FIG. 12 is a simplified diagram illustrating an example configure-UI 134 for adding action 118 in workflow builder 100. A window 1202 is provided in configure-UI 134 to enable building workflow 114 suitably using various UI elements. In the example shown, window 1202 is enabled in a workspace associated with marketplace 150 as described in reference to FIG. 11. A menu 1204 in window 1202 includes a selectable “modules” button 1206, which when selected, displays a selectable “workflows” button 1208. Selecting “workflows” button 1208 causes display of a selectable “actions” tab 1210 and a selectable “triggers” tab 1212. In the view shown, “actions” tab 1210 is selected (as indicated by bold letters merely for explanation and not as a limitation). Selecting “actions” tab 1210 causes display of selectable “create action” button 1214. Selecting “create action” button 1214 causes display of window 1216 within window 1202.

Window 1216 allows configuring certain ones of field 126 and corresponding field attributes 128 through appropriate UI elements 1218. Fields 126 may be represented by a field label 1220, such as “name” corresponding to field attribute 128. UI element 1218 may comprise a text box allowing user 136 to type in a field value 1222 for the “name” field attribute. Various fields 126 and corresponding field attributes 128 may be included within the broad scope of the disclosure. In the example shown, only field labels “name” and “key” are provided merely for explanation and not as limitations. A selectable “save” button 1224 enables saving the field values suitably. Selecting an “Add action” UI element 1218 adds the newly created action to a set of actions available to user 136 in marketplace 150.

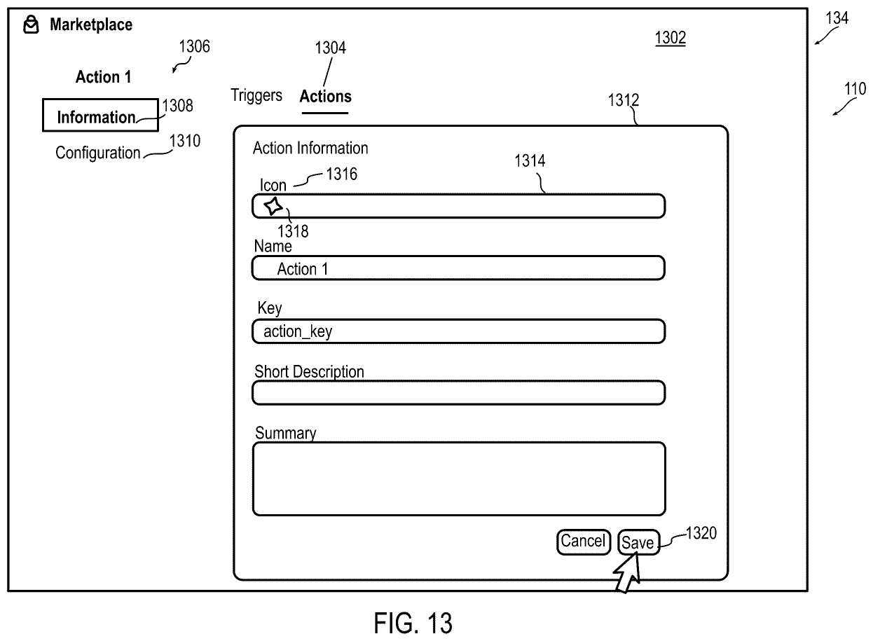

FIG. 13 is a simplified diagram illustrating an example configure-UI 134 for configuring action 118 in workflow builder 100. Selecting a particular action, such as Action 1, opens a window 1302 in configure-UI 134. In the example shown, window 1302 is enabled in a workspace associated with marketplace 150 as described in reference to FIG. 11 and displays selectable “actions” tab 1304 as selected, indicating that user 136 is in the “actions” menu for building actions 118. A menu 1306 in window 1302 includes a selectable “information” button 1308 and a selectable “configuration” button 1310. “Information” button 1308 is selected as indicated by a box and bolded text, which are merely for ease of illustration and not a limitation.

Selecting “information” button 1308 opens a window 1312 allowing for configuring additional action fields 126 and field attributes 128 with appropriate UI elements 1314. In various examples, window 1312 may be a pop-up box. Fields 126 may be represented by a field label 1316, such as “icon” corresponding to field attribute 128. UI element 1314 may comprise a text box allowing user 136 to type in a field value 1318 for the “icon” field attribute. Various fields 126 and corresponding field attributes 128 may be included within the broad scope of the disclosure. In the example shown, field labels “icon,” “name,” “key,” “short description,” and “summary” are provided merely for explanation and not as limitations. A selectable “save” button 1320 enables saving the field values suitably. Note that in some examples, the field labels may be preconfigured; in other words, only the preconfigured field labels may be made available when configuring action 118 using window 1312. This pre-configuration may be provided in first-tier WB module 106-1, for example, in prewritten object code 144. In some other examples, the field labels may be custom (e.g., generated by user 136) and made available to configure any action 118.

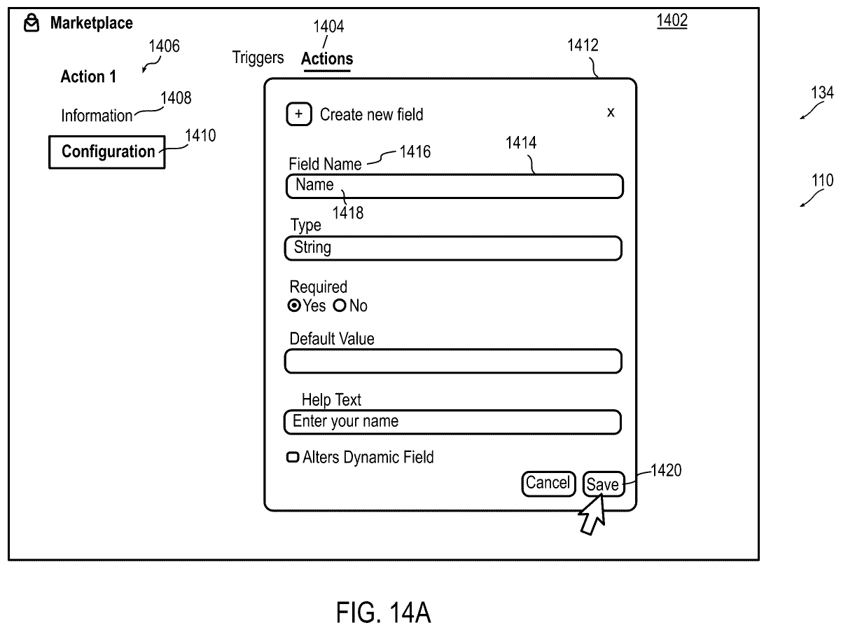

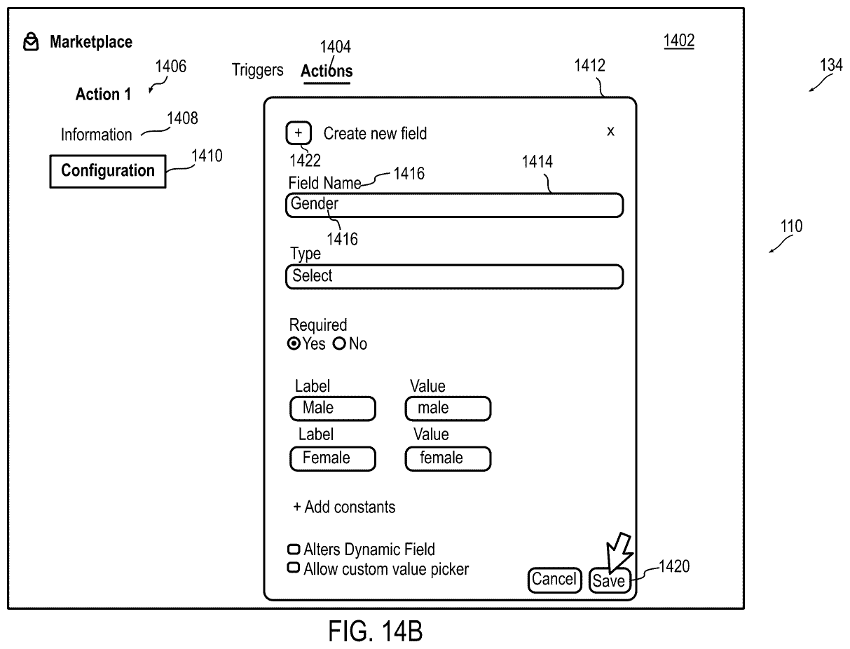

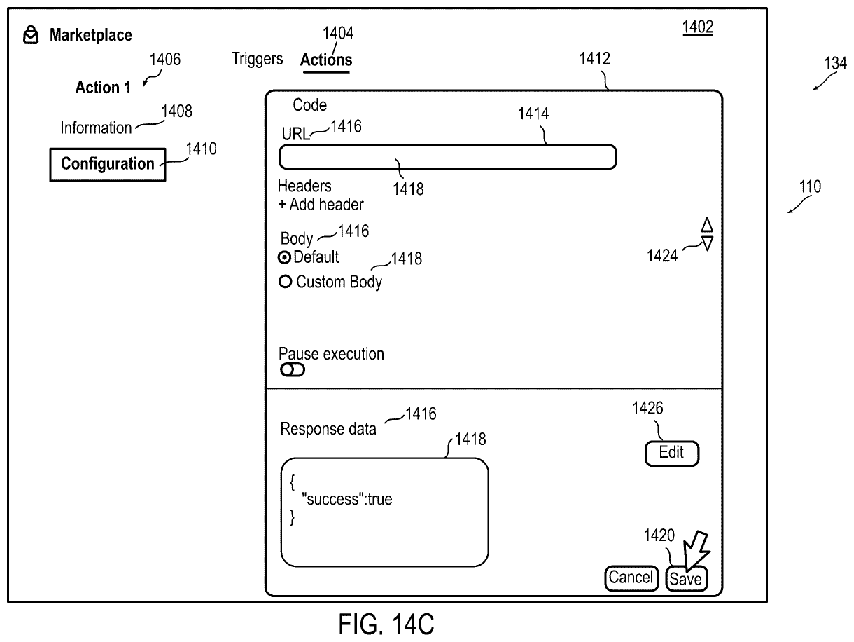

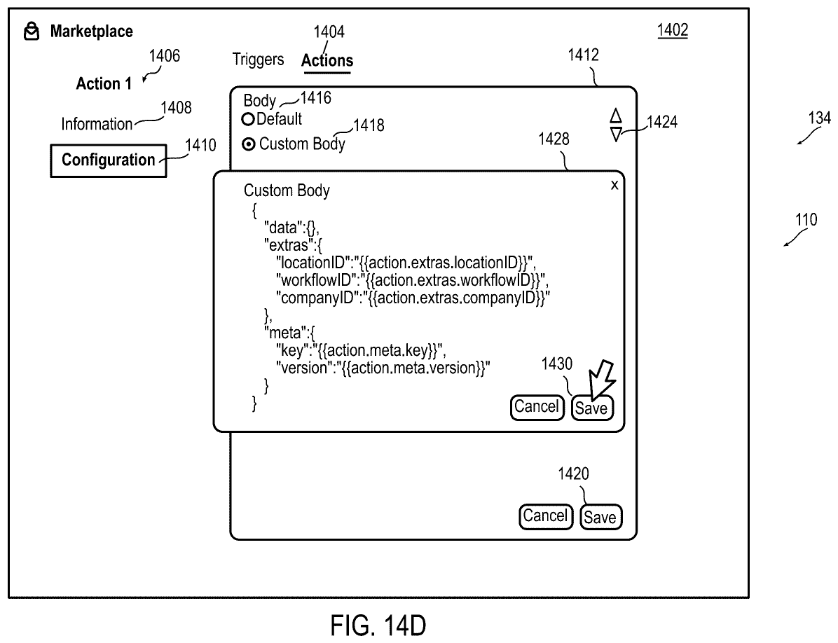

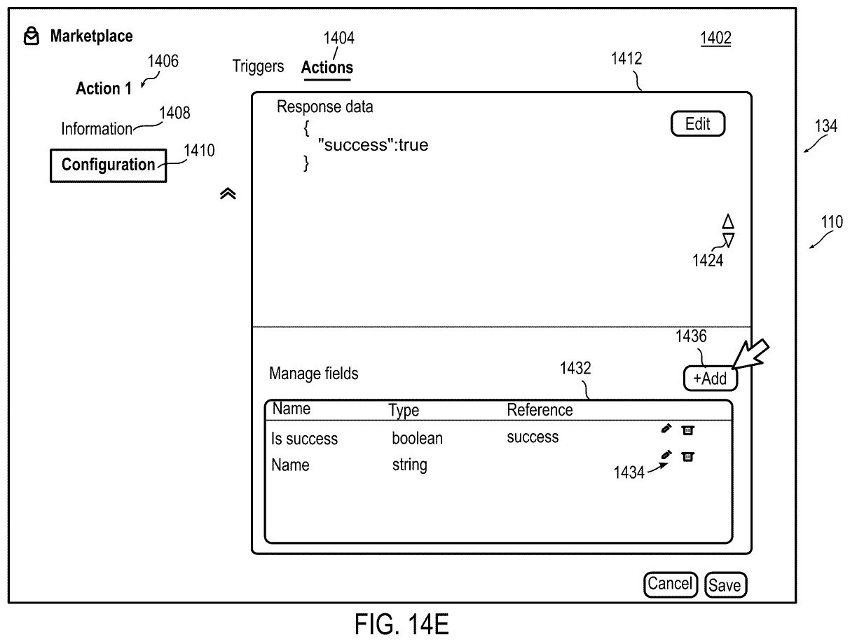

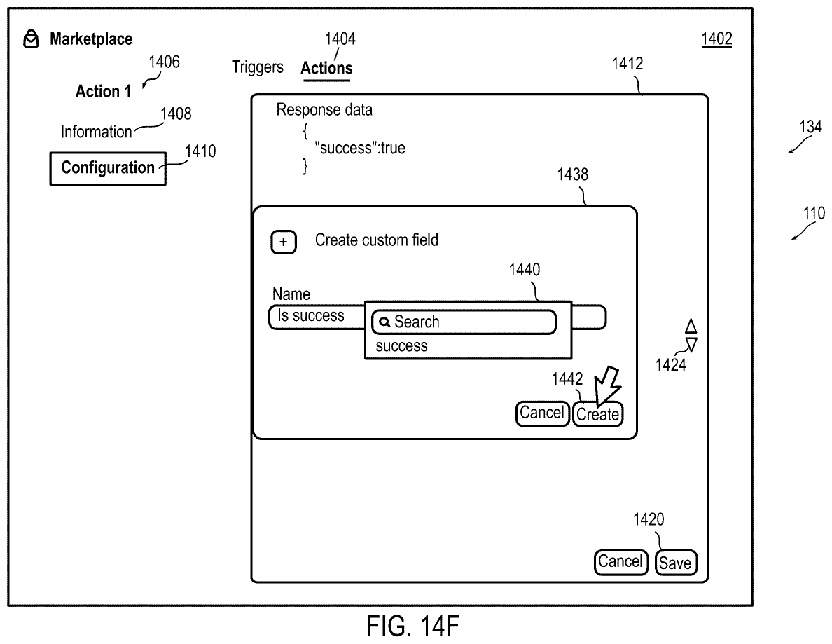

FIGS. 14A-14F are simplified diagrams illustrating an example configure-UI 134 for settings to configure action 118 in workflow builder 100. Selecting a particular action, such as Action 1, opens a window 1402 in configure-UI 134. In the example shown, window 1402 is enabled in a workspace associated with marketplace 150 as described in reference to FIG. 11 and displays selectable “actions” tab 1404 as selected, indicating that user 136 is in the “actions” menu for building actions 118. A menu 1406 in window 1402 includes a selectable “information” button 1408 and a selectable “configuration” button 1410. “Configuration” button 1410 is selected as indicated by a box and bolded text, which are merely for ease of illustration and not a limitation.

Selecting “configuration” button 1410 opens a window 1412 allowing for creating new fields 126 for configuring actions 118 with appropriate UI elements 1414. In various examples, window 1412 may be a pop-up box. Fields 126 created thus may be made available to configure action 118 as described in reference to FIG. 13. Fields 126 may be represented by a field label 1416, such as “field name” corresponding to field attribute 128. UI element 1414 may comprise a text box allowing user 136 to type in a field value 1418 for the “field name” field attribute. Various fields 126 and corresponding field attributes 128 may be included within the broad scope of the disclosure. In the example shown, field labels “field name,” “type,” “required,” “default value,” and “help text” are provided merely for explanation and not as limitations. A selectable “save” button 1420 enables saving field attributes 128 and values suitably. Note that in some examples, the field labels may be preconfigured (e.g., “required” label will have two values associated therewith, namely “yes” and “no” each selectable with a radio button); in other words, only the preconfigured field labels may be made available when configuring action 118 using window 1412. This pre-configuration may be provided in first-tier WB module 106-1, for example, in prewritten object code 144.

In the example shown, field 126 called “name” is created of type “string”. It is a required field for Action 1, without any default value (e.g., when end-user 160 is executing Action 1, end-user 160 will be required to fill in the “name” value). A help text is available to the field, “enter your name” (e.g., when Action 1 is executed, the help text will be displayed near the field to prompt end-user 160 to enter the value). Note that this example is merely one of myriad types of fields 126 that may be configured in workflow builder 100.

FIG. 14B is a simplified diagram illustrating other settings to configure action 118 in workflow builder 100. In the example shown, user 136 can generate new ones of field 126 by selecting a “create new field” button 1422. Thereupon, window 1412 is opened, allowing for creating new ones of field 126 for configuring actions 118 with appropriate UI elements 1414. Fields 126 created thus may be made available to configure action 118 as described in reference to FIG. 13. In the example shown, a new one of field 126 called “gender” is created of type “select”. It is required for action 1, per the user configuration. Labels and label values are provided, namely “male” and “female” with option to add other labels and values using “add constants” button. Note that this example is merely one of myriad types of fields 126 that may be configured in workflow builder 100.

FIG. 14C is a simplified diagram illustrating yet other settings to configure action 118 in workflow builder 100. In some examples, window 1412 may be scrollable up and down (and/or left and right) with one or more scroll element 1424 to reveal additional field labels 1416, which may be filled in with expected, default or empty field values 1418. Depending on the type of field label 1416, additional UI elements 1414 may be made available. For example, for field label “response data” indicating what the action response should be, a default code “‘success’: true” may be entered as its value, with an “edit” button 1426 to enable editing by user 136.

FIG. 14D is a simplified diagram illustrating yet other settings to configure action 118 in workflow builder 100. Selecting “custom body” as field value 1418 for field label “body” opens a window 1428 allowing for creating custom field attributes 128 with a custom script. User 136 may enter a custom script in a suitable language (e.g., JavaScript, Python, etc.) that is allowed by marketplace 150. The custom script may allow more nuanced functionalities than are possible with a no-code tool. A selectable “save” button 1430 enables saving the custom script suitably. In some examples, the allowed field labels using custom script may be limited by prewritten object code 144. In other examples, any type of field 126 and field labels may be generated using the custom script. The custom script may allow for defining dependencies and mappings that are not natively available in the prewritten code and objects of first-tier WB module 106-1.

FIG. 14E is a simplified diagram illustrating other settings to configure action 118 in workflow builder 100. A window 1432 may allow for managing fields 126. A list of fields 126 configured for the selected action 118 (e.g., Action 1) is displayed in window 1432, with appropriate UI elements 1434 to edit or delete them. An “add” button 1436 allows user 136 to add additional field 126 to action 1.

FIG. 14F is a simplified diagram illustrating adding other additional field labels to field 126 of action 118 in workflow builder 100. Selecting “add” button 1436 opens a window 1438. Window 1438 allows user 136 to generate new or additional fields 126 and associated variables. A search window 1440 may allow searching for variables in marketplace 150, or within a smaller workspace, such as in configurations of action 118, or in other account data (e.g., actions or workflows that have been previously purchased by user 136 on marketplace 150). A selectable “create” button 1442 enables generating and saving the custom one of field 126 suitably. In some examples, the settings as described herein may be available in one single scrollable window 1412. In some other examples, the settings as described herein may be available in separate ones of window 1412. Various other such UI configurations may be made available without departing from the scope of the disclosure herein.

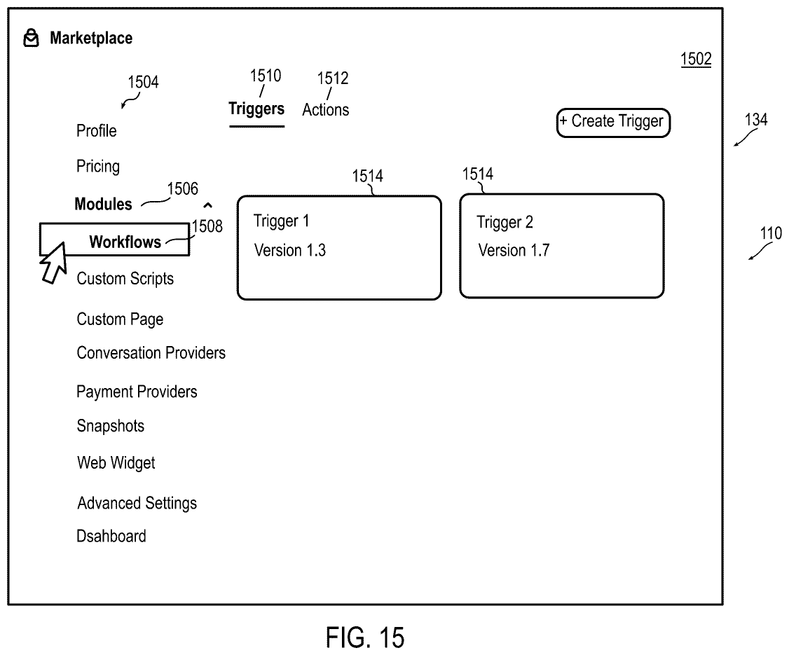

FIG. 15 is a simplified diagram illustrating an example configure-UI 134 for adding trigger 120 in workflow builder 100. A window 1502 is provided in configure-UI 134 to enable building workflow 114 suitably using various UI elements. In the example shown, window 1502 is enabled in a workspace associated with marketplace 150 as described in reference to FIG. 11. A menu 1504 in window 1502 includes a selectable “modules” button 1506, which when selected, displays a selectable “workflows” button 1508. Selecting “workflows” button 1508 causes display of a selectable “triggers” tab 1510 and a selectable “actions” tab 1512. In the view shown, “triggers” tab 1510 is selected (as indicated by bold letters merely for explanation and not as a limitation). Selecting “triggers” tab 1510 causes display of various triggers 120 suitably in selectable boxes 1514.

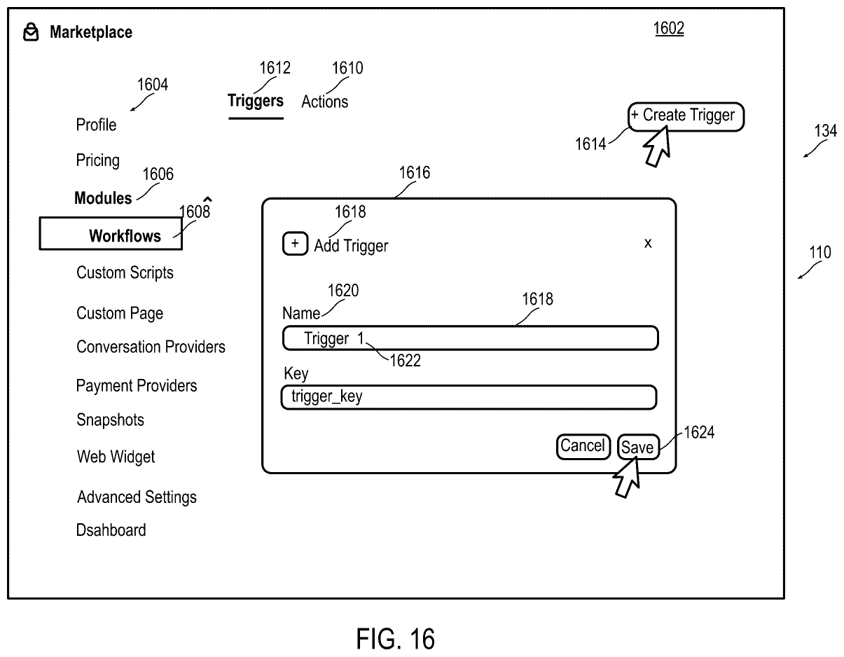

FIG. 16 is a simplified diagram illustrating an example configure-UI 134 for adding trigger 120 in workflow builder 100. A window 1602 is provided in configure-UI 134 to enable building workflow 114 suitably using various UI elements. In the example shown, window 1602 is enabled in a workspace associated with marketplace 150 as described in reference to FIG. 11. A menu 1604 in window 1602 includes a selectable “modules” button 1606, which when selected, displays a selectable “workflows” button 1608. Selecting “workflows” button 1608 causes display of a selectable “triggers” tab 1610 and a selectable “actions” tab 1612. In the view shown, “triggers” tab 1610 is selected (as indicated by bold letters merely for explanation and not as a limitation). Selecting “triggers” tab 1610 causes display of selectable “create trigger” button 1614. Selecting “create trigger” button 1614 causes display of window 1616 within window 1602.

Window 1616 allows configuring certain filter 130 and corresponding filter attribute 132 through appropriate UI elements 1618. Filter 130 may be represented by a filter label 1620, such as “name” corresponding to filter attribute 132. UI element 1618 may comprise a text box allowing user 136 to type in a value 1622 for the “name” filter attribute. Various filters and corresponding filter attributes may be included within the broad scope of the disclosure. In the example shown, only filter labels “name” and “key” are provided merely for explanation and not as limitations. A selectable “save” button 1624 enables saving the filter values suitably. Selecting an “Add trigger” UI element 1618 adds the newly created trigger to a set of actions available to user 136 in marketplace 150.

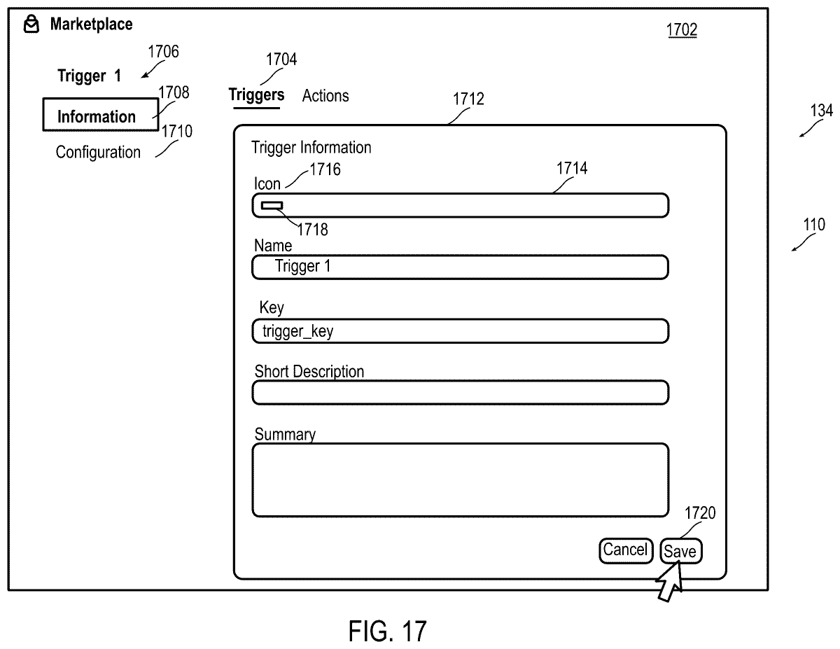

FIG. 17 is a simplified diagram illustrating an example configure-UI 134 for configuring action 118 in workflow builder 100. Selecting a particular trigger, such as Trigger 1, opens a window 1702 in configure-UI 134. In the example shown, window 1702 is enabled in a workspace associated with marketplace 150 as described in reference to FIG. 11 and displays selectable “triggers” tab 1704 as selected, indicating that user 136 is in the “triggers” menu for building triggers 120. A menu 1706 in window 1702 includes a selectable “information” button 1708 and a selectable “configuration” button 1710. “Information” button 1708 is selected as indicated by a box and bolded text, which are merely for ease of illustration and not a limitation.

Selecting “information” button 1708 opens a window 1712 allowing for configuring additional trigger 120 and filter attribute 132 with appropriate UI elements 1714. In various examples, window 1712 may be a pop-up box. Filters 130 may be represented by a filter label 1716, such as “icon” corresponding to filter attribute 132. UI element 1714 may comprise a text box allowing user 136 to type in or otherwise enter a suitable value 1718 for the “icon” filter attribute. Various filters 130 and corresponding filter attributes 132 may be included within the broad scope of the disclosure. In the example shown, filter labels “icon,” “name,” “key,” “short description,” and “summary” are provided merely for explanation and not as limitations. A selectable “save” button 1720 enables saving the filter values suitably. Note that in some examples, the filter labels may be preconfigured; in other words, only the preconfigured filter labels may be made available when configuring trigger 120 using window 1712. This pre-configuration may be provided in first-tier WB module 106-1, for example, in prewritten object code 144. In some other examples, the filter labels may be custom (e.g., generated by user 136) and made available to configure any trigger 120.

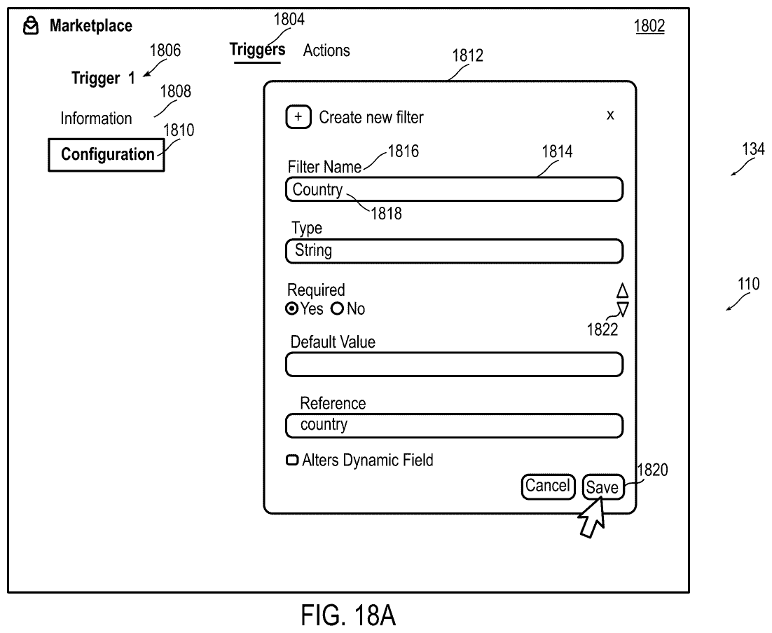

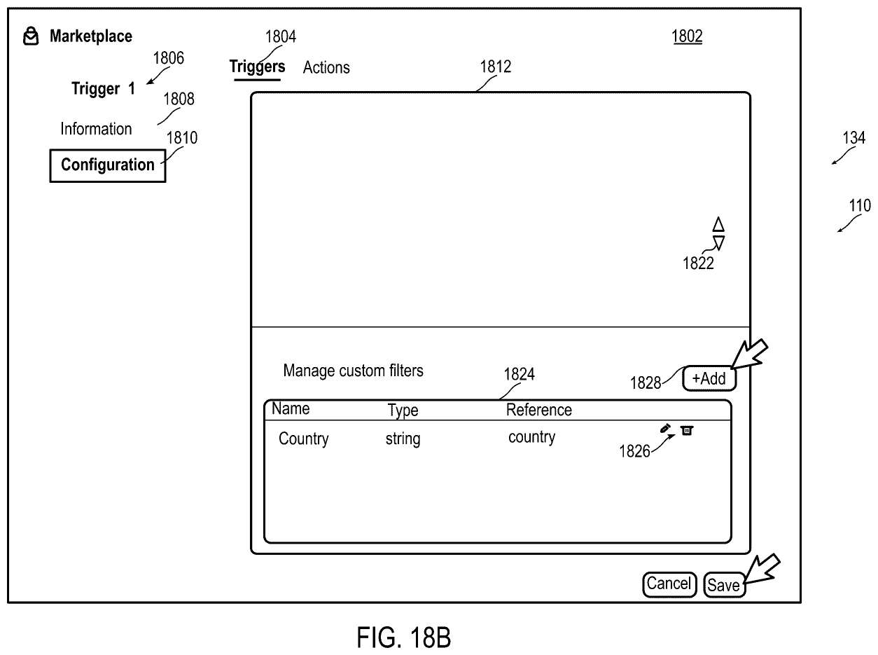

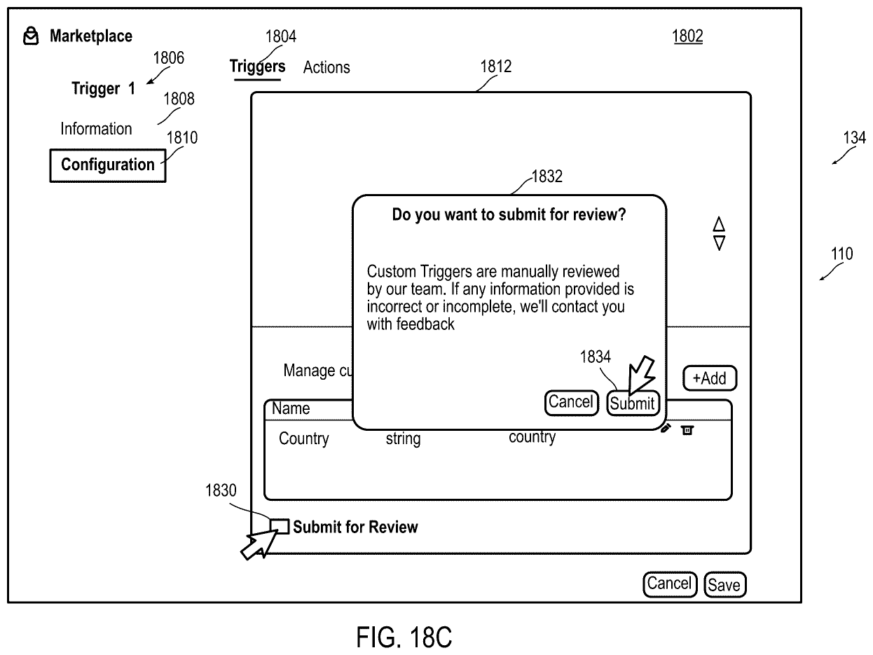

FIGS. 18A-18B are simplified diagrams illustrating an example configure-UI 134 for settings to configure trigger 120 in workflow builder 100. Selecting a particular trigger, such as Trigger 1, opens a window 1802 in configure-UI 134. In the example shown, window 1802 is enabled in a workspace associated with marketplace 150 as described in reference to FIG. 11 and displays selectable “Triggers” tab 1804 as selected, indicating that user 136 is in the “Triggers” menu for building trigger 120. A menu 1806 in window 1802 includes a selectable “information” button 1808 and a selectable “configuration” button 1810. “Configuration” button 1810 is selected as indicated by a box and bolded text, which are merely for ease of illustration and not a limitation.

Selecting “configuration” button 1810 opens a window 1812 allowing for creating new filters 130 for configuring trigger 120 with appropriate UI elements 1814. In various examples, window 1812 may be a pop-up box. Filters 130 created thus may be made available to configure trigger 120 as described in reference to FIG. 17. Filters 10 may be represented by a filter label 1816, such as “Filter Name” corresponding to filter attribute 132. UI element 1814 may comprise a text box allowing user 136 to type in a suitable value 1818 for the “Filter Name” filter attribute. Various filters 130 and corresponding filter attributes 132 may be included within the broad scope of the disclosure. In the example shown, filter labels “filter name,” “type,” “required,” “default value,” and “reference” are provided merely for explanation and not as limitations.

A selectable “save” button 1820 enables saving filter attributes 132 and values suitably. In some examples, window 1812 may be scrollable up and down (and/or left and right) with one or more scroll element 1822 to reveal additional configurable elements. Note that in some examples, the filter labels may be preconfigured (e.g., “required” label will have two values associated therewith, namely “yes” and “no” each selectable with a radio button); in other words, only the preconfigured filter labels may be made available when configuring trigger 120 using window 1812. This pre-configuration may be provided in first-tier WB module 106-1, for example, in prewritten object code 144.

In the example shown, a new filter 130 called “filter name” is created of type “string”. It is required for trigger 1, without any default value. The reference is “country” which indicates the association of the newly configured filter with the pre-configured variable “country” in first-tier WB module 106-1. Note that this example is merely one of myriad types of filters 130 that may be configured in workflow builder 100.

FIG. 18B is a simplified diagram illustrating yet other settings to configure trigger 120 in workflow builder 100. A window 1824 may allow for managing filters 130. A list of filters 130 configured for the selected trigger 1 is displayed in window 1824, with appropriate UI elements 1826 to edit or delete them. An “add” button 1828 allows user 136 to add additional filter 130 to trigger 1. Note that FIGS. 11-18B illustrate an example configure-UI 134 that allows user 136 to build workflow 114 irrespective of any technical or coding expertise or know-how, democratizing the application build process so that non-technical users can create sophisticated workflows similar in functional complexities as those created by knowledgeable software developers. In addition, various technical processes such as debugging code, testing, etc. are simplified or eliminated with configure-UI 134.

FIG. 18C is a simplified diagram illustrating yet other settings to configure trigger 120 in workflow builder 100. In the example shown, a selectable UI element 1830 is provided to submit the newly created trigger 1 for review by professional software developers. Selecting UI element 1830 opens window 1832, which displays a suitable message (e.g., “Custom Triggers are manually reviewed by our team. If any information provided is incorrect or incomplete, we'll contact you with feedback”) to alert user 136, with another “submit” UI element 1834 to submit for review.

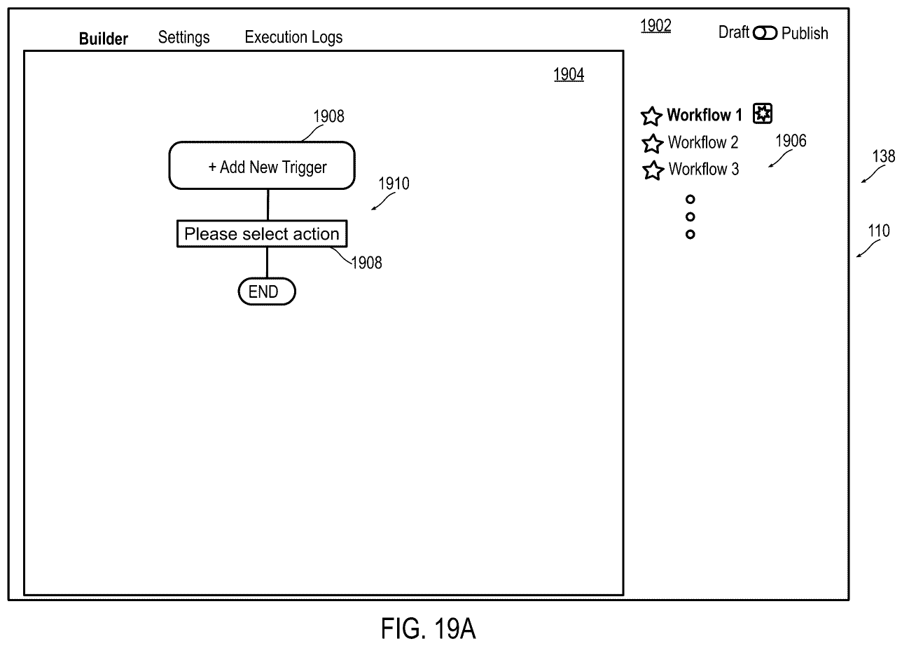

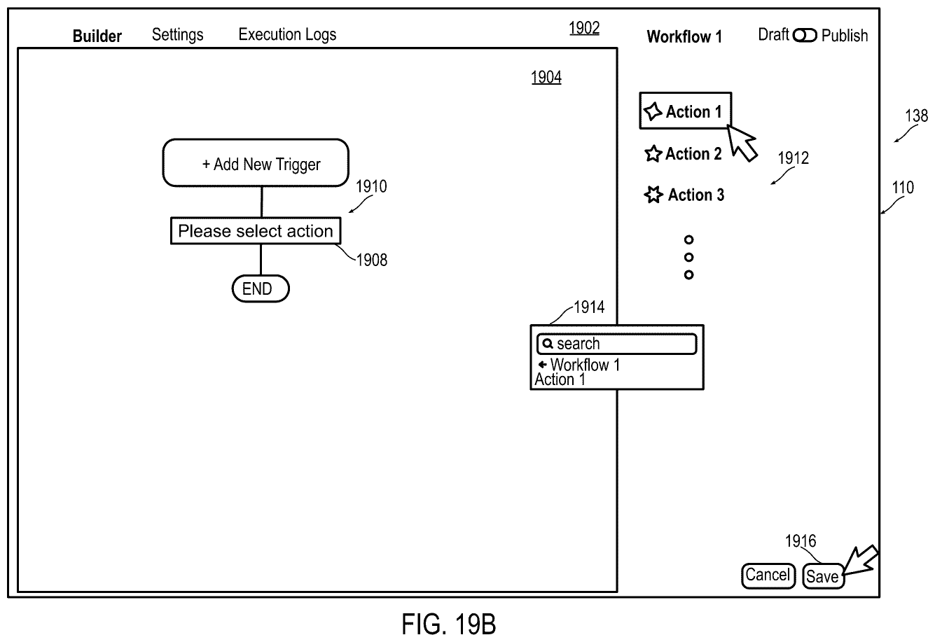

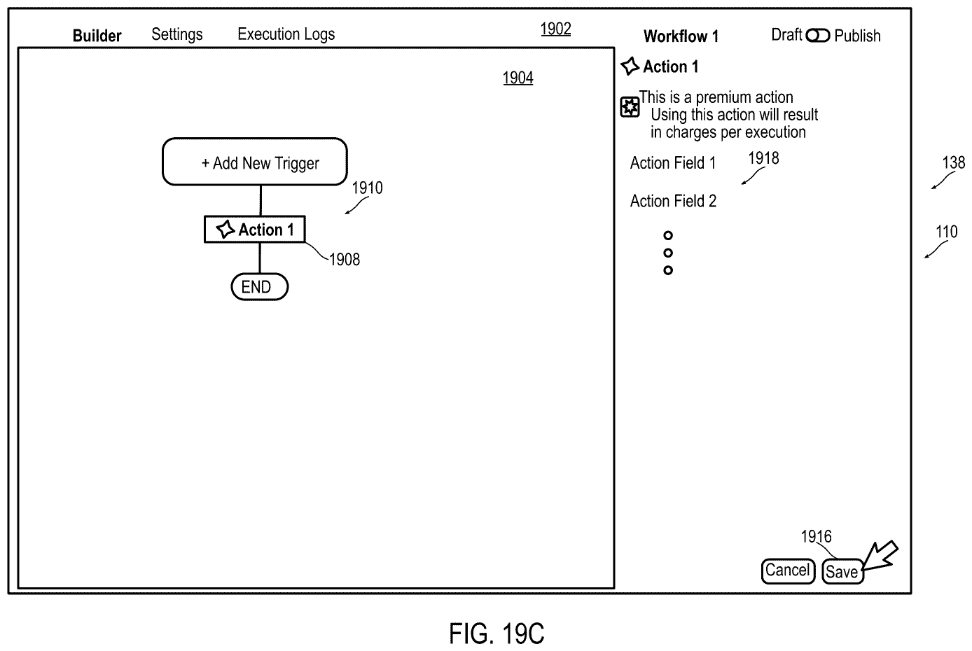

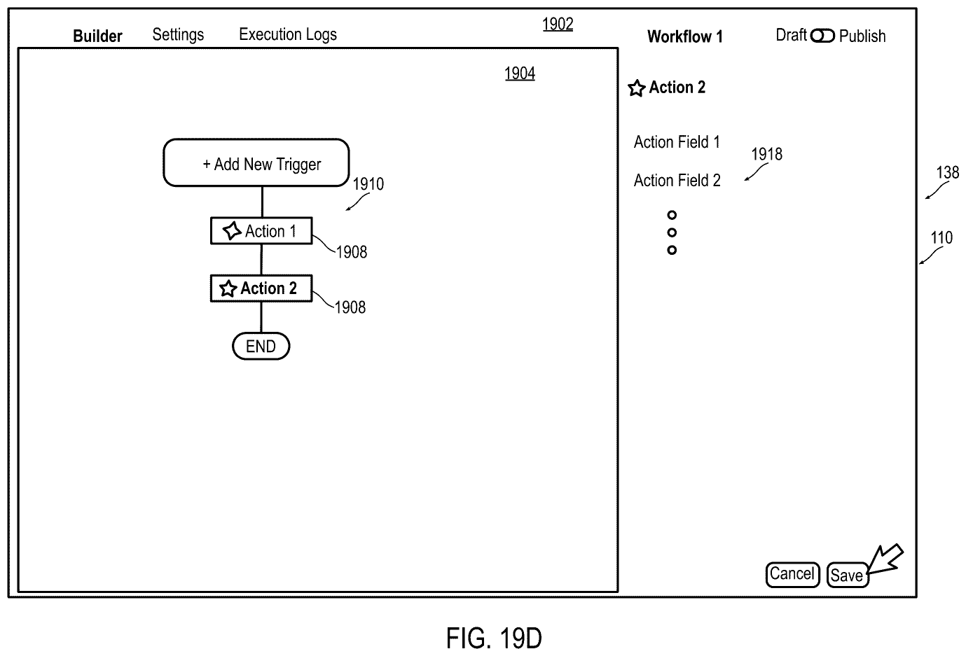

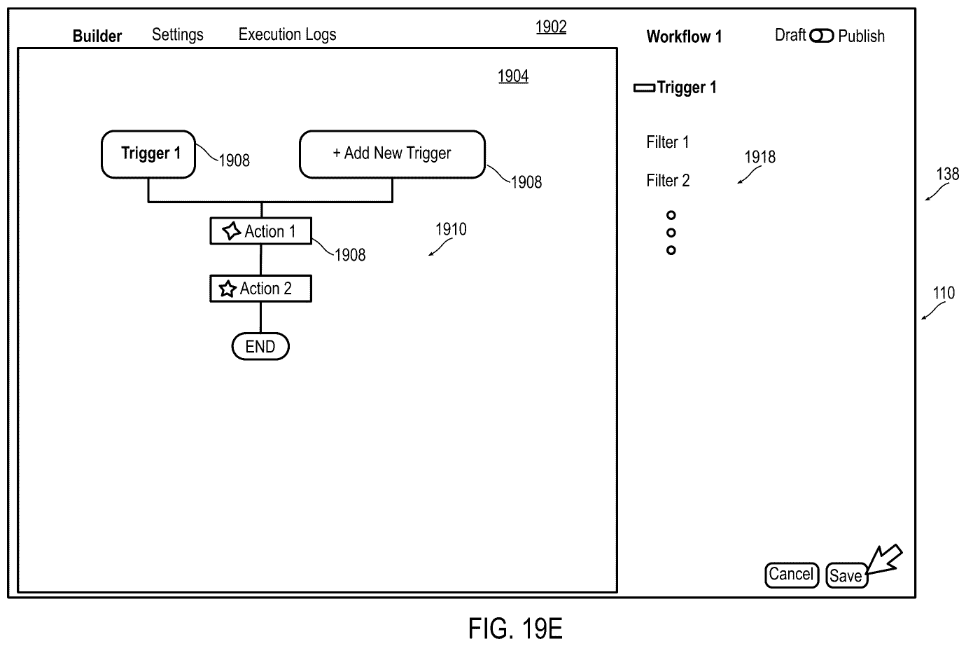

FIGS. 19A-19E are simplified diagrams illustrating building of workflow 114 with action 118 and trigger 120 in workflow builder 100 using an example build-UI 138. FIG. 19A illustrates a simplified diagram of build-UI 138, comprising a window 1902 displaying various selectable options, such as “builder,” “settings,” and “execution logs.” A build space 1904 permits user 136 to add actions 118 and trigger 120 in suitable ways to build workflow 114. Actions 118 and triggers 120 may be shown in a visually clutter-free manner in build space 1904. A list of available workflows 114 may be shown as a list 1906 to facilitate selection for configuration or build by user 136. Selection of one of the listed workflows may display it in build space 1904. In the view shown, workflow 1 is selected (as indicated in bolded letters merely for illustration and not as a limitation). As workflow 1 is new and not configured, default “add new trigger” and “please select action” UI elements 1908 are displayed in build space 1904 as a layout 1910 with interconnected workflow-object 116. Layout 1910 comprises a visual mapping (e.g., as a flow diagram in the example shown) of workflow-objects 116, such as actions 118 and triggers 120 interconnected according to dependency 122.

FIG. 19B shows a view upon selecting a specific workflow 1 to build and selecting the “please select action” UI element 1908. Custom actions 118 that have been created as described in previous figures as well as native actions 118 preconfigured in first-tier WB module 106-1 and third-party developer generated actions 118 may be displayed or made available to build workflow 114. In the example shown, such actions 118 are displayed as a selectable list 1912 adjacent to build space 1904. In some examples, a search box 1914 may pop up to enable searching for available ones of action 118 to add to workflow 114. A selectable “save” button 1916 enables saving workflow 114 as metadata 124.

FIG. 19C shows a view upon selecting a specific action 1 with UI element 1908. A selectable list 1918 is displayed adjacent to build space 1904 showing fields 126 of the selection action 1. In some examples, user 136 may modify values of fields 126 in window 1902. In other examples, user 136 can only see the values, whereas modifying them may be done only in the configuration modules as described in FIGS. 14A-14F.

FIG. 19D shows a view indicating that many actions (e.g., action 1,action 2, etc.) may be added to layout 1910. Although only two actions are shown in the figure, such is merely for ease of illustration. Any number of actions may be added to layout 1910 within the scope of the disclosure. Further, any number of branches may also be added to layout 1910; for example, action 3 may branch from action 1, rather than follow sequentially after action 2; and so on.

FIG. 19E shows a view indicating that trigger 1 is added to layout 1910. According to the flow logic, action 1 will initiate upon occurrence of trigger 1. In the example shown, in which trigger 1 is selected (as indicated in bold), selectable list 1918 displays various attributes of trigger 1. In some examples, additional trigger 120 may be added upon selecting UI element 1908 “Add New Trigger”.

FIGS. 19A-19E show various ways of building workflow 114 in build space 1904. In some examples, actions 118 and triggers 120 may be added by dragging and dropping from selectable list 1918 into build space 1904. Any number of actions 118, trigger 120 and branches may be added to generate layout 1910 for workflow 114. Further, FIGS. 11-19E are merely illustrative examples of certain selections available in configure-UI 134 and build-UI 138. Various other selections relevant to building workflow 114 are available in either user interfaces. Configure-UI 134 and build-UI 138 are intended to be user-friendly, providing familiar UI elements and user-actions (e.g., click-to-select, drag-and-drop, “save” button, “cancel” button, menus, lists, etc.) that are intuitive while building complex workflows 114 without prior knowledge of any sort of software code. This improves the efficiency of using the computing device by bringing together a limited list of common functions with options to add sophisticated software code as needed to build complex workflow-objects 116 based on particular needs. Additionally, the common functions may be limited to the relevant industry of tiered software framework 200, such as marketing, so that workflow builder 100 is lean and tailored to its most relevant users. User 136 need not be aware of their respective tiers, or concerned with data access permissions as workflow builder 100 automatically enables appropriate tier-based access to data and functionalities. For the foregoing reasons, workflow builder 100 provides various improvements over existing computer technology.

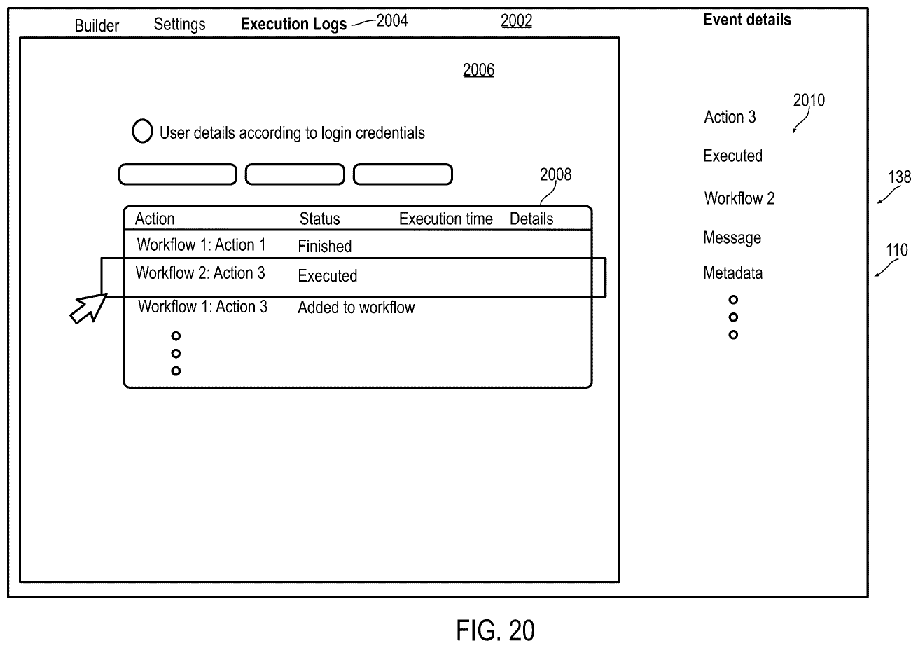

FIG. 20 is a simplified diagram illustrating an example build-UI 138 for building workflow 114 in workflow builder 100. Window 2002 includes a selectable “Execution Logs” tab 2004, which when selected, opens window 2006, displaying a log 2008 of various workflow-object 116. Log 2008 enables user 136 and/or end-user 160 to review workflow 114 upon execution. Each action 118 is selectable; selecting one, as indicated by the rectangle and arrow, displays details 2010 associated with the selected action beside window 2006. Details 2010 may include various configuration settings as well as any other metadata 124 associated with the selected action.

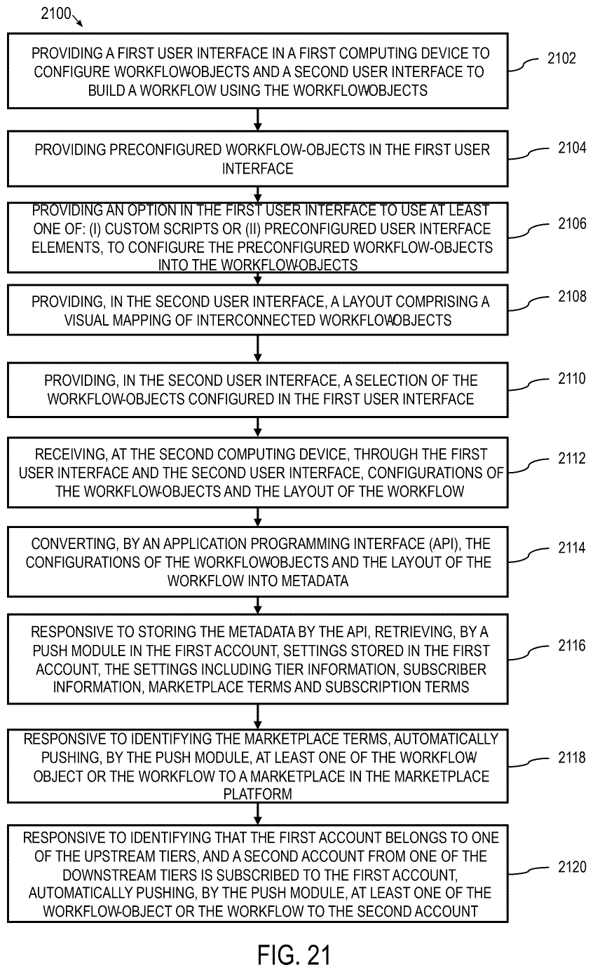

FIG. 21 is a simplified flow diagram illustration example operations 2100 for building workflow 114 in tiered software framework 200. At 2102, a first user interface (e.g., config-UI 134) is provided in a first computing device (e.g., through front-end 216) to configure workflow-objects 116 and a second user interface (e.g., build-UI 138) is provided to build workflow 114 using workflow-objects 116. As described previously, the first user interface and the second user interface are in marketplace platform 110. In one example, the first user interface and the second user interface are accessed by user 136 with access credentials associated with a first account, and at least a portion of tiered software framework 200 executes in a second computing device (e.g., back-end 214) remote from the first computing device. In various examples, the first computing device and the second computing device communicate over cloud network 202.

At 2104, preconfigured workflow-objects 116 are provided in the first user interface. In an example, preconfigured workflow-objects 116 are relevant to a context of tiered software framework 200. For example, the context may comprise marketing. At 2106, an option is provided in the first user interface to use at least one of: (i) custom scripts or (ii) preconfigured UI elements, to configure preconfigured workflow-objects 116 into workflow-objects 116. Note that workflow-object 116 comprises any one or more of action 118, trigger 120, and dependency 122. The configurations of action 118 comprise fields 126 having field attributes128; the configurations of trigger 120 comprise filters 130 having filter attributes 132; and the configurations of dependency 122 comprise relationships among actions 118 or between actions 118 and triggers 120.At this step, field attributes 128 and filter attributes 132 may be modified suitably from the preconfigured values by user 136.

At 2108, layout 1910 is provided in the second user interface. In various examples, layout 1910 comprises a visual mapping of interconnected workflow-objects 116. At 2110, a selection of workflow-objects 116 is provided in the second user interface, workflow-object 116 being previously configured in the first user interface. In some examples, the selection further comprises at least one of the preconfigured workflow-objects 116, workflow-objects 116 purchased from marketplace 150, or workflow-objects 116 shared from another account in tiered software framework 200. In an example, user 136 selects workflow-objects 116 from the selection and adds selected workflow-objects 116 to layout 1910. At 2112, configurations of workflow-objects 116 and layout 1910 of workflow 114 are received at the second computing device through the first user interface and the second user interface. At 2114, API 140 converts the configurations of workflow-objects 116 and layout 1910 of workflow 114 into metadata 124. At 2116, responsive to storing metadata 124 by API 140, push module 154 in the first account, retrieves settings 152 stored in the first account, settings 152 including tier information, subscriber information, marketplace terms and subscription terms.

At 2118, responsive to identifying the marketplace terms, push module 154 automatically pushes at least one of workflow-object 116 or workflow 114 to marketplace 150 in marketplace platform 110. In some examples, workflow-object 116 or workflow 114 is available to any account in any tier 102 according to the marketplace terms. At 2120, responsive to identifying that the first account belongs to one of the upstream tiers (e.g., second-tier 102-2), and a second account from one of the downstream tiers (e.g., third-tier 102-3) is subscribed to the first account, push module 154 automatically pushes at least one of workflow-object 116 or workflow 114 to the second account. In some examples, workflow-object 116 or workflow 114 is available to the second account according to subscription terms stored in the first account. In some examples, responsive to identifying that the first account belongs to one of the downstream tiers, push module 154 is prevented from pushing workflow-object 116 and workflow 114 to any other account.

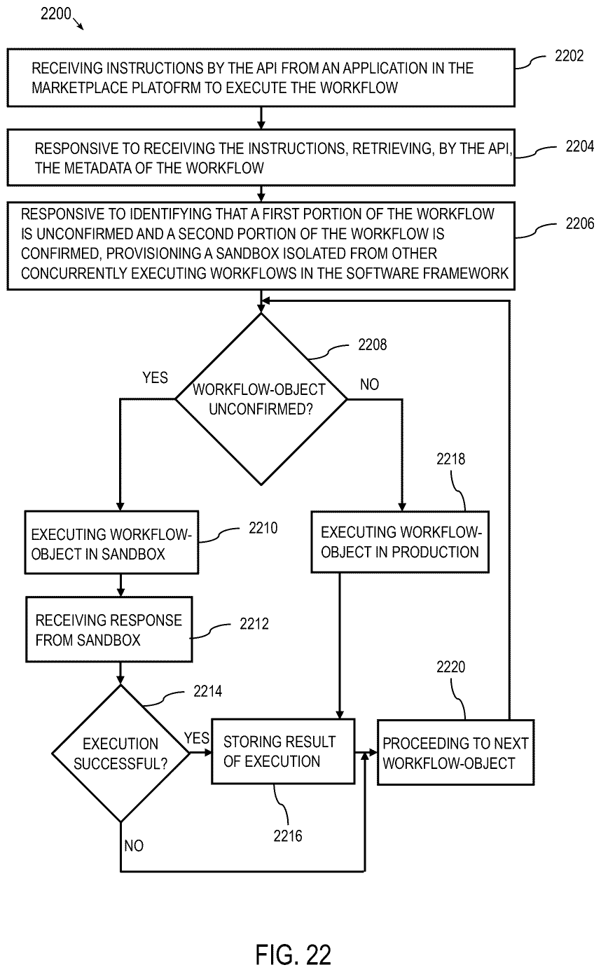

FIG. 22 is a simplified flow diagram illustrating operations 2200 associated with building workflow 114 in tiered software framework 200. At 2202, API 140 receives instructions from application 112 in marketplace platform 110 to execute workflow 114. In some examples, such application 112 may be a third-party application. At 2204, responsive to receiving the instructions, API 140 retrieves metadata 124 of workflow 114. At 2206, responsive to identifying that a first portion of workflow 114 is unconfirmed and a second portion of workflow 114 is confirmed, deployment engine 146 provisions sandbox 402 isolated from other concurrently executing workflows in tiered software framework 200. As described previously, sandbox 402 comprises a restricted execution space with access to a limited set of calls to API 140, whereas production 404 comprises an unrestricted execution space with access to more than the limited set of calls to API 140.

Thereafter, workflow 114 is executed, comprising the following operations. The first workflow-object 116 is identified and reviewed. At 2208, a determination is made whether workflow-object 116 is unconfirmed, i.e., it belongs to the first portion of workflow 114. Responsive to identifying workflow-object 116 as unconfirmed, at 2210, workflow-object 116 is executed in sandbox 402 according to the configurations. At 2212, API 140 receives a response from sandbox 402 after executing workflow-object 116. In some examples, the response indicates a status of executing workflow-object 116 as successful or unsuccessful. In some examples, the response also includes execution metadata (e.g., status code, runtime logs, or basic confirmation) but not necessarily the final processed result. At 2214, a determination is made whether the response indicates the execution as successful. Responsive to identifying the status as successful, at 2216, API 140 stores a result generated by executing workflow-object 116 for later retrieval. In various examples, the result comprises data produced by executing workflow-object 116, such as a newly generated record identifier, a calculated value, a response payload from an external API, etc.) The result depends on the configurations of workflow-object 116.

Moving back to 2208, responsive to identifying workflow-object 116 as belonging to the second portion, at 2218, deployment engine 146 sends workflow-object 116 to production 404 and workflow-object 116 is executed in production 404 according to the configurations and the operations continue to 2216. At 2220, a next one of workflow-object 116 in workflow 114 is identified according to metadata 124, and the operations step to 2208 and continue thereafter, until all workflow-objects 116 of workflow 114 complete execution.

In various embodiments, substantially most operations described in the various figures are performed automatically without human intervention. Although the figures illustrate various operations performed in a particular order, this is simply illustrative, and the operations discussed herein may be reordered and/or repeated as suitable. Further, additional operations which are not illustrated may also be performed without departing from the scope of the present disclosure. Also, various ones of the operations discussed herein with respect to the figures may be modified in accordance with the present disclosure to automatically build workflows as disclosed herein. Although various operations are illustrated in the figures once each, the operations may be repeated as often as desired.

It is important to note that the operations described with reference to the preceding figures illustrate only some of the possible scenarios that may be executed by, or within, the workflow builder Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion.

### EXAMPLES

Example 1 provides a method for building and executing workflows in a tiered software framework, the method comprising: providing a first user interface in a first computing device to configure workflow-objects and a second user interface in the first computing device to build a workflow using the workflow-objects, wherein: the first user interface and the second user interface are in a marketplace platform of a tiered software framework, the tiered software framework includes a plurality of tiers with accounts in downstream tiers subscribed to different accounts in upstream tiers, the first user interface and the second user interface are accessed by a user with access credentials associated with a first account, and at least a portion of the tiered software framework executes in a second computing device remote from the first computing device; providing preconfigured workflow-objects in the first user interface, wherein the preconfigured workflow-objects are relevant to a context of the tiered software framework; providing an option in the first user interface to use at least one of: (i) custom scripts or (ii) preconfigured user interface elements, to configure the preconfigured workflow-objects into the workflow-objects; providing, in the second user interface, a layout comprising a visual mapping of interconnected workflow-objects; providing, in the second user interface, a selection comprising the workflow-objects configured in the first user interface; receiving, at the second computing device, through the first user interface and the second user interface, configurations of the workflow-objects and the layout of the workflow; converting, by an application programming interface (API), the configurations of the workflow-objects and the layout of the workflow into metadata; responsive to storing the metadata by the API, retrieving, by a push module in the first account, settings stored in the first account, the settings including tier information, subscriber information, marketplace terms and subscription terms; responsive to identifying the marketplace terms, automatically pushing, by the push module, at least one of the workflow-object or the workflow to a marketplace in the marketplace platform, wherein the workflow-object or the workflow is available to any account in any tier according to the marketplace terms; and responsive to identifying that the first account belongs to one of the upstream tiers, and a second account from one of the downstream tiers is subscribed to the first account, automatically pushing, by the push module, at least one of the workflow-object or the workflow to the second account, wherein the workflow-object or the workflow is available to the second account according to subscription terms stored in the first account.

Example 2 provides the method of example 1, further comprising: receiving instructions, by the API from an application in the marketplace platform, to execute the workflow; responsive to receiving the instructions, retrieving, by the API, the metadata of the workflow; responsive to identifying that a first portion of the workflow is unconfirmed and a second portion of the workflow is confirmed, provisioning a sandbox isolated from other concurrently executing workflows in the tiered software framework; and executing the workflow-objects of the workflow according to the metadata, the executing comprising: for each workflow-object in the workflow: responsive to identifying the workflow-object as belonging to the first portion, executing the workflow-object in the sandbox according to the configurations; receiving a response from the sandbox after executing the workflow-object, wherein the response indicates a status of executing the workflow-object as successful or unsuccessful; responsive to identifying the status as successful, storing a result generated by executing the workflow-object for later retrieval; responsive to identifying the workflow-object as belonging to the second portion, executing the workflow-object in production according to the configurations and storing the result generated by executing the workflow-object for later retrieval; and identifying a next workflow-object in the workflow according to the metadata, until all the workflow-objects of the workflow complete execution.

Example 3 provides the method of example 2, wherein the sandbox comprises a restricted execution space with access to a limited set of calls to the API, and the production comprises an unrestricted execution space with access to more than the limited set of calls to the API.

Example 4 provides the method of example 1, wherein the selection further comprises at least one of the preconfigured workflow-objects, workflow-objects purchased from the marketplace, or workflow-objects shared from another account.

Example 5 provides the method of example 1, further comprising, responsive to identifying that the first account belongs to one of the downstream tiers, preventing pushing, by the push module, the workflow-object and the workflow to any other account.

Example 6 provides the method of example 1, wherein: the tiered software framework includes a first tier, a second tier and a third tier, the first tier being upstream from the second tier and the third tier, and the third tier being downstream from the first tier and the second tier, data access among the first tier, the second tier and the third tier is governed by data access policies, such that upstream data is not accessible by downstream tiers and downstream data is accessible by upstream tiers, and the marketplace platform is provided in the second tier.

Example 7 provides the method of example 1, wherein the workflow-object comprises at least one of an action, a trigger, or a dependency.

Example 8 provides the method of example 7, wherein: the configurations of the action comprise fields having field attributes, configurations of the trigger comprise filters having filter attributes, and configurations of the dependency comprise relationships among the actions or between actions and triggers.

Example 9 provides non-transitory computer-readable tangible media that includes instructions for execution, which when executed by a processor of a computing device, is operable to perform operations comprising: providing a first user interface in a first computing device to configure workflow-objects and a second user interface in the first computing device to build a workflow using the workflow-objects, wherein: the first user interface and the second user interface are in a marketplace platform of a tiered software framework, the tiered software framework includes a plurality of tiers with accounts in downstream tiers subscribed to different accounts in upstream tiers, the first user interface and the second user interface are accessed by a user with access credentials associated with a first account, and at least a portion of the tiered software framework executes in a second computing device remote from the first computing device; providing preconfigured workflow-objects in the first user interface, wherein the preconfigured workflow-objects are relevant to a context of the tiered software framework; providing an option in the first user interface to use at least one of: (i) custom scripts or (ii) preconfigured user interface elements, to configure the preconfigured workflow-objects into the workflow-objects; providing, in the second user interface, a layout comprising a visual mapping of interconnected workflow-objects; providing, in the second user interface, a selection comprising the workflow-objects configured in the first user interface; receiving, at the second computing device, through the first user interface and the second user interface, configurations of the workflow-objects and the layout of the workflow; converting, by an application programming interface (API), the configurations of the workflow-objects and the layout of the workflow into metadata; responsive to storing the metadata by the API, retrieving, by a push module in the first account, settings stored in the first account, the settings including tier information, subscriber information, marketplace terms and subscription terms; responsive to identifying the marketplace terms, automatically pushing, by the push module, at least one of the workflow-object or the workflow to a marketplace in the marketplace platform, wherein the workflow-object or the workflow is available to any account in any tier according to the marketplace terms; and responsive to identifying that the first account belongs to one of the upstream tiers, and a second account from one of the downstream tiers is subscribed to the first account, automatically pushing, by the push module, at least one of the workflow-object or the workflow to the second account, wherein the workflow-object or the workflow is available to the second account according to subscription terms stored in the first account.

Example 10 provides the non-transitory computer-readable tangible media of example 9, the operations further comprising: receiving instructions, by the API from an application in the marketplace platform, to execute the workflow; responsive to receiving the instructions, retrieving, by the API, the metadata of the workflow; responsive to identifying that a first portion of the workflow is unconfirmed and a second portion of the workflow is confirmed, provisioning a sandbox isolated from other concurrently executing workflows in the tiered software framework; and executing the workflow-objects of the workflow according to the metadata, the executing comprising: for each workflow-object in the workflow: responsive to identifying the workflow-object as belonging to the first portion, executing the workflow-object in the sandbox according to the configurations; receiving a response from the sandbox after executing the workflow-object, wherein the response indicates a status of executing the workflow-object as successful or unsuccessful; responsive to identifying the status as successful, storing a result generated by executing the workflow-object for later retrieval; responsive to identifying the workflow-object as belonging to the second portion, executing the workflow-object in production according to the configurations and storing the result generated by executing the workflow-object for later retrieval; and identifying a next workflow-object in the workflow according to the metadata, until all the workflow-objects of the workflow complete execution.

Example 11 provides the non-transitory computer-readable tangible media of example 10, wherein the sandbox comprises a restricted execution space with access to a limited set of calls to the API, and the production comprises an unrestricted execution space with access to more than the limited set of calls to the API.

Example 12 provides the non-transitory computer-readable tangible media of example 9, wherein the selection further comprises at least one of the preconfigured workflow-objects, workflow-objects purchased from the marketplace, or workflow-objects shared from another account.

Example 13 provides the non-transitory computer-readable tangible media of example 9, the operations further comprising, responsive to identifying that the first account belongs to one of the downstream tiers, preventing pushing, by the push module, the workflow-object and the workflow to any other account.

Example 14 provides the non-transitory computer-readable tangible media of example 9, wherein: the tiered software framework includes a first tier, a second tier and a third tier, the first tier being upstream from the second tier and the third tier, and the third tier being downstream from the first tier and the second tier, data access among the first tier, the second tier and the third tier is governed by data access policies, such that upstream data is not accessible by downstream tiers and downstream data is accessible by upstream tiers, and the marketplace platform is provided in the second tier.

Example 15 provides an apparatus comprising: a processing circuitry; a memory storing data; and a communication circuitry, wherein the processing circuitry executes instructions associated with the data, the processing circuitry is coupled to the communication circuitry and the memory, and the processing circuitry and the memory cooperate, such that the apparatus is configured for: providing a first user interface in a first computing device to configure workflow-objects and a second user interface in the first computing device to build a workflow using the workflow-objects, wherein: the first user interface and the second user interface are in a marketplace platform of a tiered software framework, the tiered software framework includes a plurality of tiers with accounts in downstream tiers subscribed to different accounts in upstream tiers, the first user interface and the second user interface are accessed by a user with access credentials associated with a first account, and at least a portion of the tiered software framework executes in the apparatus remote from the first computing device; providing preconfigured workflow-objects in the first user interface, wherein the preconfigured workflow-objects are relevant to a context of the tiered software framework; providing an option in the first user interface to use at least one of: (i) custom scripts or (ii) preconfigured user interface elements, to configure the preconfigured workflow-objects into the workflow-objects; providing, in the second user interface, a layout comprising a visual mapping of interconnected workflow-objects; providing, in the second user interface, a selection comprising the workflow-objects configured in the first user interface; receiving, at the apparatus, through the first user interface and the second user interface, configurations of the workflow-objects and the layout of the workflow; converting, by an application programming interface (API), the configurations of the workflow-objects and the layout of the workflow into metadata; responsive to storing the metadata by the API, retrieving, by a push module in the first account, settings stored in the first account, the settings including tier information, subscriber information, marketplace terms and subscription terms; responsive to identifying the marketplace terms, automatically pushing, by the push module, at least one of the workflow-object or the workflow to a marketplace in the marketplace platform, wherein the workflow-object or the workflow is available to any account in any tier according to the marketplace terms; and responsive to identifying that the first account belongs to one of the upstream tiers, and a second account from one of the downstream tiers is subscribed to the first account, automatically pushing, by the push module, at least one of the workflow-object or the workflow to the second account, wherein the workflow-object or the workflow is available to the second account according to subscription terms stored in the first account.

Example 16 provides the apparatus of example 15, further configured for: receiving instructions, by the API from an application in the marketplace platform, to execute the workflow; responsive to receiving the instructions, retrieving, by the API, the metadata of the workflow; responsive to identifying that a first portion of the workflow is unconfirmed and a second portion of the workflow is confirmed, provisioning a sandbox isolated from other concurrently executing workflows in the tiered software framework; and executing the workflow-objects of the workflow according to the metadata, the executing comprising: for each workflow-object in the workflow: responsive to identifying the workflow-object as belonging to the first portion, executing the workflow-object in the sandbox according to the configurations; receiving a response from the sandbox after executing the workflow-object, wherein the response indicates a status of executing the workflow-object as successful or unsuccessful; responsive to identifying the status as successful, storing a result generated by executing the workflow-object for later retrieval; responsive to identifying the workflow-object as belonging to the second portion, executing the workflow-object in production according to the configurations and storing the result generated by executing the workflow-object for later retrieval; and identifying a next workflow-object in the workflow according to the metadata, until all the workflow-objects of the workflow complete execution.

Example 17 provides the apparatus of example 16, wherein the sandbox comprises a restricted execution space with access to a limited set of calls to the API, and the production comprises an unrestricted execution space with access to more than the limited set of calls to the API.

Example 18 provides the apparatus of example 15, wherein the selection further comprises at least one of the preconfigured workflow-objects, workflow-objects purchased from the marketplace, or workflow-objects shared from another account.

Example 19 provides the apparatus of example 15, further configured for responsive to identifying that the first account belongs to one of the downstream tiers, preventing pushing, by the push module, the workflow-object and the workflow to any other account.

Example 20 provides the apparatus of example 15, wherein: the tiered software framework includes a first tier, a second tier and a third tier, the first tier being upstream from the second tier and the third tier, and the third tier being downstream from the first tier and the second tier, data access among the first tier, the second tier and the third tier is governed by data access policies, such that upstream data is not accessible by downstream tiers and downstream data is accessible by upstream tiers, and the marketplace platform is provided in the second tier.

The above description of illustrated implementations of the disclosure, including what is described in the abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

1. A method for building and executing workflows in a tiered software framework, the method comprising:
providing a first user interface in a first computing device to configure workflow-objects and a second user interface in the first computing device to build a workflow using the workflow-objects, wherein:
the first user interface and the second user interface are in a marketplace platform of a tiered software framework,
the tiered software framework includes a plurality of tiers with accounts in downstream tiers subscribed to different accounts in upstream tiers,
the first user interface and the second user interface are accessed by a user with access credentials associated with a first account, and
at least a portion of the tiered software framework executes in a second computing device remote from the first computing device;
providing preconfigured workflow-objects in the first user interface, wherein the preconfigured workflow-objects are relevant to a context of the tiered software framework;
providing an option in the first user interface to use at least one of: (i) custom scripts or (ii) preconfigured user interface elements, to configure the preconfigured workflow-objects into the workflow-objects;
providing, in the second user interface, a layout comprising a visual mapping of interconnected workflow-objects;
providing, in the second user interface, a selection comprising the workflow-objects configured in the first user interface;
receiving, at the second computing device, through the first user interface and the second user interface, configurations of the workflow-objects and the layout of the workflow;
converting, by an application programming interface (API), the configurations of the workflow-objects and the layout of the workflow into metadata;
responsive to storing the metadata by the API, retrieving, by a push module in the first account, settings stored in the first account, the settings including tier information, subscriber information, marketplace terms and subscription terms;
responsive to identifying the marketplace terms, automatically pushing, by the push module, at least one of the workflow-object or the workflow to a marketplace in the marketplace platform, wherein the workflow-object or the workflow is available to any account in any tier according to the marketplace terms; and
responsive to identifying that the first account belongs to one of the upstream tiers, and a second account from one of the downstream tiers is subscribed to the first account, automatically pushing, by the push module, at least one of the workflow-object or the workflow to the second account, wherein the workflow-object or the workflow is available to the second account according to subscription terms stored in the first account.

2. The method of claim 1, further comprising:
receiving instructions, by the API from an application in the marketplace platform, to execute the workflow;
responsive to receiving the instructions, retrieving, by the API, the metadata of the workflow;
responsive to identifying that a first portion of the workflow is unconfirmed and a second portion of the workflow is confirmed, provisioning a sandbox isolated from other concurrently executing workflows in the tiered software framework; and
executing the workflow-objects of the workflow according to the metadata, the executing comprising:
for each workflow-object in the workflow:
responsive to identifying the workflow-object as belonging to the first portion, executing the workflow-object in the sandbox according to the configurations;
receiving a response from the sandbox after executing the workflow-object, wherein the response indicates a status of executing the workflow-object as successful or unsuccessful;
responsive to identifying the status as successful, storing a result generated by executing the workflow-object for later retrieval;
responsive to identifying the workflow-object as belonging to the second portion, executing the workflow-object in production according to the configurations and storing the result generated by executing the workflow-object for later retrieval; and
identifying a next workflow-object in the workflow according to the metadata, until all the workflow-objects of the workflow complete execution.

3. The method of claim 2, wherein the sandbox comprises a restricted execution space with access to a limited set of calls to the API, and the production comprises an unrestricted execution space with access to more than the limited set of calls to the API.

4. The method of claim 1, wherein the selection further comprises at least one of the preconfigured workflow-objects, workflow-objects purchased from the marketplace, or workflow-objects shared from another account.

5. The method of claim 1, further comprising, responsive to identifying that the first account belongs to one of the downstream tiers, preventing pushing, by the push module, the workflow-object and the workflow to any other account.

6. The method of claim 1, wherein:
the tiered software framework includes a first tier, a second tier and a third tier, the first tier being upstream from the second tier and the third tier, and the third tier being downstream from the first tier and the second tier,
data access among the first tier, the second tier and the third tier is governed by data access policies, such that upstream data is not accessible by downstream tiers and downstream data is accessible by upstream tiers, and
the marketplace platform is provided in the second tier.

7. The method of claim 1, wherein the workflow-object comprises at least one of an action, a trigger, or a dependency.

8. The method of claim 7, wherein:
the configurations of the action comprise fields having field attributes, configurations of the trigger comprise filters having filter attributes, and
configurations of the dependency comprise relationships among the actions or between actions and triggers.

9. Non-transitory computer-readable tangible media that includes instructions for execution, which when executed by a processor of a computing device, is operable to perform operations comprising:
providing a first user interface in a first computing device to configure workflow-objects and a second user interface in the first computing device to build a workflow using the workflow-objects, wherein:
the first user interface and the second user interface are in a marketplace platform of a tiered software framework,
the tiered software framework includes a plurality of tiers with accounts in downstream tiers subscribed to different accounts in upstream tiers,
the first user interface and the second user interface are accessed by a user with access credentials associated with a first account, and
at least a portion of the tiered software framework executes in a second computing device remote from the first computing device;
providing preconfigured workflow-objects in the first user interface, wherein the preconfigured workflow-objects are relevant to a context of the tiered software framework;
providing an option in the first user interface to use at least one of: (i) custom scripts or (ii) preconfigured user interface elements, to configure the preconfigured workflow-objects into the workflow-objects;
providing, in the second user interface, a layout comprising a visual mapping of interconnected workflow-objects;
providing, in the second user interface, a selection comprising the workflow-objects configured in the first user interface;
receiving, at the second computing device, through the first user interface and the second user interface, configurations of the workflow-objects and the layout of the workflow;
converting, by an application programming interface (API), the configurations of the workflow-objects and the layout of the workflow into metadata;
responsive to storing the metadata by the API, retrieving, by a push module in the first account, settings stored in the first account, the settings including tier information, subscriber information, marketplace terms and subscription terms;
responsive to identifying the marketplace terms, automatically pushing, by the push module, at least one of the workflow-object or the workflow to a marketplace in the marketplace platform, wherein the workflow-object or the workflow is available to any account in any tier according to the marketplace terms; and
responsive to identifying that the first account belongs to one of the upstream tiers, and a second account from one of the downstream tiers is subscribed to the first account, automatically pushing, by the push module, at least one of the workflow-object or the workflow to the second account, wherein the workflow-object or the workflow is available to the second account according to subscription terms stored in the first account.

10. The non-transitory computer-readable tangible media of claim 9, the operations further comprising:
receiving instructions, by the API from an application in the marketplace platform, to execute the workflow;
responsive to receiving the instructions, retrieving, by the API, the metadata of the workflow;
responsive to identifying that a first portion of the workflow is unconfirmed and a second portion of the workflow is confirmed, provisioning a sandbox isolated from other concurrently executing workflows in the tiered software framework; and
executing the workflow-objects of the workflow according to the metadata, the executing comprising:
for each workflow-object in the workflow:
responsive to identifying the workflow-object as belonging to the first portion, executing the workflow-object in the sandbox according to the configurations;
receiving a response from the sandbox after executing the workflow-object, wherein the response indicates a status of executing the workflow-object as successful or unsuccessful;
responsive to identifying the status as successful, storing a result generated by executing the workflow-object for later retrieval;
responsive to identifying the workflow-object as belonging to the second portion, executing the workflow-object in production according to the configurations and storing the result generated by executing the workflow-object for later retrieval; and
identifying a next workflow-object in the workflow according to the metadata, until all the workflow-objects of the workflow complete execution.

11. The non-transitory computer-readable tangible media of claim 10, wherein the sandbox comprises a restricted execution space with access to a limited set of calls to the API, and the production comprises an unrestricted execution space with access to more than the limited set of calls to the API.

12. The non-transitory computer-readable tangible media of claim 9, wherein the selection further comprises at least one of the preconfigured workflow-objects, workflow-objects purchased from the marketplace, or workflow-objects shared from another account.

13. The non-transitory computer-readable tangible media of claim 9, the operations further comprising, responsive to identifying that the first account belongs to one of the downstream tiers, preventing pushing, by the push module, the workflow-object and the workflow to any other account.

14. The non-transitory computer-readable tangible media of claim 9, wherein:
the tiered software framework includes a first tier, a second tier and a third tier, the first tier being upstream from the second tier and the third tier, and the third tier being downstream from the first tier and the second tier,
data access among the first tier, the second tier and the third tier is governed by data access policies, such that upstream data is not accessible by downstream tiers and downstream data is accessible by upstream tiers, and
the marketplace platform is provided in the second tier.

15. An apparatus comprising:
a processing circuitry;
a memory storing data; and
a communication circuitry, wherein the processing circuitry executes instructions associated with the data, the processing circuitry is coupled to the communication circuitry and the memory, and the processing circuitry and the memory cooperate, such that the apparatus is configured for:
providing a first user interface in a first computing device to configure workflow-objects and a second user interface in the first computing device to build a workflow using the workflow-objects, wherein:
the first user interface and the second user interface are in a marketplace platform of a tiered software framework,
the tiered software framework includes a plurality of tiers with accounts in downstream tiers subscribed to different accounts in upstream tiers,
the first user interface and the second user interface are accessed by a user with access credentials associated with a first account, and
at least a portion of the tiered software framework executes in the apparatus remote from the first computing device;
providing preconfigured workflow-objects in the first user interface, wherein the preconfigured workflow-objects are relevant to a context of the tiered software framework;
providing an option in the first user interface to use at least one of: (i) custom scripts or (ii) preconfigured user interface elements, to configure the preconfigured workflow-objects into the workflow-objects;
providing, in the second user interface, a layout comprising a visual mapping of interconnected workflow-objects;
providing, in the second user interface, a selection comprising the workflow-objects configured in the first user interface;
receiving, at the apparatus, through the first user interface and the second user interface, configurations of the workflow-objects and the layout of the workflow;
converting, by an application programming interface (API), the configurations of the workflow-objects and the layout of the workflow into metadata;
responsive to storing the metadata by the API, retrieving, by a push module in the first account, settings stored in the first account, the settings including tier information, subscriber information, marketplace terms and subscription terms;
responsive to identifying the marketplace terms, automatically pushing, by the push module, at least one of the workflow-object or the workflow to a marketplace in the marketplace platform, wherein the workflow-object or the workflow is available to any account in any tier according to the marketplace terms; and
responsive to identifying that the first account belongs to one of the upstream tiers, and a second account from one of the downstream tiers is subscribed to the first account, automatically pushing, by the push module, at least one of the workflow-object or the workflow to the second account, wherein the workflow-object or the workflow is available to the second account according to subscription terms stored in the first account.

16. The apparatus of claim 15, further configured for:
receiving instructions, by the API from an application in the marketplace platform, to execute the workflow;
responsive to receiving the instructions, retrieving, by the API, the metadata of the workflow;
responsive to identifying that a first portion of the workflow is unconfirmed and a second portion of the workflow is confirmed, provisioning a sandbox isolated from other concurrently executing workflows in the tiered software framework; and
executing the workflow-objects of the workflow according to the metadata, the executing comprising:
for each workflow-object in the workflow:
responsive to identifying the workflow-object as belonging to the first portion, executing the workflow-object in the sandbox according to the configurations;
receiving a response from the sandbox after executing the workflow-object, wherein the response indicates a status of executing the workflow-object as successful or unsuccessful;
responsive to identifying the status as successful, storing a result generated by executing the workflow-object for later retrieval;
responsive to identifying the workflow-object as belonging to the second portion, executing the workflow-object in production according to the configurations and storing the result generated by executing the workflow-object for later retrieval; and
identifying a next workflow-object in the workflow according to the metadata, until all the workflow-objects of the workflow complete execution.

17. The apparatus of claim 16, wherein the sandbox comprises a restricted execution space with access to a limited set of calls to the API, and the production comprises an unrestricted execution space with access to more than the limited set of calls to the API.

18. The apparatus of claim 15, wherein the selection further comprises at least one of the preconfigured workflow-objects, workflow-objects purchased from the marketplace, or workflow-objects shared from another account.

19. The apparatus of claim 15, further configured for responsive to identifying that the first account belongs to one of the downstream tiers, preventing pushing, by the push module, the workflow-object and the workflow to any other account.

20. The apparatus of claim 15, wherein:
the tiered software framework includes a first tier, a second tier and a third tier, the first tier being upstream from the second tier and the third tier, and the third tier being downstream from the first tier and the second tier,
data access among the first tier, the second tier and the third tier is governed by data access policies, such that upstream data is not accessible by
downstream tiers and downstream data is accessible by upstream tiers, and the marketplace platform is provided in the second tier.
